(19) United States
(12) Patent Application Publication
(10) Pub. No.: US 2010/0253519 A1
(43) Pub. Date: Oct. 7, 2010

(54) UNDERDECK CARRIER SYSTEM FOR MOBILE CONTAINERS FOR SEGREGATING PRODUCT TYPES IN COMMON SHIPMENT

(75) Inventors: Rogers Brackmann, St. Charles, IL (US); Dennis Kossnar, Batavia, IL (US)

Correspondence Address: PATENT ADMINISTRATOR;NEAL, GERBER, & EISENBERG, SUITE 1700, 2 NORTH LASALLE STREET, CHICAGO, IL, 60602, US

(73) Assignee: Private Pallet Security Systems, LLC, Warrenville, IL (US)

(21) Appl. No.: 11/959,444

(22) Filed: Dec. 18, 2007

Related U.S. Application Data
(63) Continuation-in-part of application No. 11/375,504, filed on Mar. 13, 2006, now Pat. No. 7,482,928.
Application No. 11/375,504 is a continuation-in-part of application No. 11/128,879, filed on May 13, 2005, now Pat. No. 7,714,708.
Application No. 11/128,879 is a continuation-in-part of application No. 10/330,149, filed on Dec. 27, 2002, now Pat. No. 7,011,214.
(60) Provisional application No. 60/870,456, filed on Dec. 18, 2006.
(60) Provisional application No. 60/871,027, filed on Dec. 20, 2006.
(60) Provisional application No. 60/374,871, filed on Apr. 22, 2002.
(60) Provisional application No. 60/344,010, filed on Dec. 28, 2001.

(51) Int. Cl. G08B 13/14

(52) U.S. Cl. 340/572.1

(57) ABSTRACT

A transportation system for secure, auditable and trackable smart mobile containers (SMC) for securely shipping less than truckload volumes of products that require special handing segregation as controlled products, such as ethical drugs, along with general, non-controlled merchandise. Dedicated semi-trailer lockers are secured under the deck I-beam framing, including lockable fold-down doors that become ramps for loading/unloading. The lockers are mounted back to back along the center line of the trailer under-deck. Each SMC includes a electronics package that can read RFID tags, has condition sensors and an RF module to permit remote monitoring of location and cargo/container conditions. The SMC can include an electronic lock that provides access security, and an audit trail of all opening and closing events.

### CROSS REFERENCE TO RELATED APPLICATIONS

This application is a Non-Provisional Application of U.S. Provisional Application No. 60/870,456, filed on Dec. 18, 2006 entitled Underdeck Carrier System for Mobile Containers for Segregating Product Types in Common Shipment, and is a Non-Provisional Application of U.S. Provisional Patent Application 60/871,027, filed on Dec. 20, 2006 entitled System for Maintaining Security of Evidence Throughout Chain of Custody. This application is also a Continuation-In-Part Application which claims priority to U.S. application Ser. No. 11/375,304, filed on Mar. 13, 2006 entitled Private Pallet-Box Cargo Shipping System, and to U.S. application Ser. No. 11/128,879, filed on May 13, 2005 entitled Small Pallet-Box Cargo Container, and to U.S. application Ser. No. 10/330,149, filed on Dec. 27, 2002 entitled Private Pallet-Box Cargo Shipping system, which issued as U.S. Pat. No. 7,011,214 on Mar. 14, 2006, which claims priority from U.S. Provisional Application No. 60/374,871, filed on Apr. 22, 2002 entitled Private Pallet Box Shipping System With Universal Hanger and Cam Lock Systems, and to U.S. Provisional Application No. 60/344,010, filed on Dec. 28, 2001 entitled Private Pallet Shipping System. All of the above-mentioned patent applications and patents are hereby incorporated by reference in their entirety.

### FIELD OF THE INVENTION

This invention relates to carrier systems for transport of goods that must be segregated within a common shipment, such as ethical drugs and controlled-distribution products, and more particularly to a segregated products, truck transport system comprising under-deck locker system for special, high security, auditable, trackable, wheeled smart mobile containers (SMCs). The system also includes provision for load/unload inventory of individual packages via reading RF tags and relaying the data via a communications network to remote locations for at least tracking and inventory functions.

### BACKGROUND OF THE INVENTION

In the trucking industry, a problem arises when products must be segregated by nature or value from other products in the same shipment going to the same or related locations. For example, in the case of prescription and over the counter drugs, ethical/controlled drugs must be handled separately from the generic and over the counter branded drugs, vitamins, analgesics and the like, in large part because of the nature of the ethical/controlled drugs, the legal and regulatory handling protocols and their street value.

In most cases, the ethicals are separately delivered under special protocols and in special trucks, including bonded or security-type vehicles. That is, the ethicals are not mingled and loaded along with the OTC products, as the truck interiors are not secure. Since the volume of ethicals going to a single address, such as a hospital, clinic or pharmacy; are typically far less than semi-trailer load (STL), the separate shipping adds substantially to the distribution cost. For special materials, collectively called biologicals, such as serum, blood, transplant tissue, vaccines and the like, very expensive, high-speed courier transport under controlled temperature conditions is required.

Accordingly, there is a need in the industry to provide a system whereby ethical/controlled drugs and biologicals can be securely shipped along with non-critical OTC-type products in the same semi-trailer load for economy of scale and more efficient load logistics.

### SUMMARY OF THE INVENTION

The invention is directed to an under-deck locker system that is application-specific to special highly secure, auditable and trackable Smart Mobile Containers (defined below and abbreviated SMCs) for securely shipping products that are less than truckload volumes yet require segregation and special handling, e.g., products such as ethical and controlled drugs and biological materials, along with other products, that do not require special handling or legal distribution control, to common addresses. The invention comprises semi-trailer under-deck lockers that are secured to the deck I-beam under-framing, which lockers include lockable fold-down doors that serve as ramps for the SMCs. The lockers are specially sized to receive the SMCs, typically one SMC per locker. The lockers are mounted back to back along the center line of the trailer under-deck, and longitudinally between the tractor rear wheels and the trailer rear wheel bogie. Typically six lockers can be fit in the available space, three on each side.

The lockers may be insulated or/and connected to heating and cooling units of the transport trucks. Thus, refrigeration elements embedded in the sided walls of the lockers are connectable via flex lines to the truck refrigeration units, and embedded floor and side wall resistance heaters are connected to the truck auxiliary electrical system. These heating and cooling units can be tailored to the 12V electrical systems of the trucks. Both heating and cooling are controlled by temperature sensors in the lockers. Or, in the alternative, the SMCs contain temperature sensors that are linked to and communicate the temperature condition inside the SMC to an on-board monitor or alarm system to provide automatic cycling of the needed cooling or heating or alerts to the driver to take remedial action as needed. Thus, Temperature set point deviation can be detected, monitored and alarmed, as well as rate of change of T as an anticipatory, proactive control parameter.

In addition, each SMC unit optionally includes thermally insulated side walls, top and bottom, e.g., 1-2″ urethane foam insulation, to assist in maintaining thermal control of the contents. Together, the insulation, heating and cooling systems maintain biologicals at preset temperatures, typically in the range of 35-55° F. during transport.

Optionally, and presently preferred, the interior of the locker includes internal bumpers, dunnage bags, or other cushioning devices or elements which prevent the SMCs from shifting and banging during transport, yet permit adequate clearance for loading and unloading the SMCs. In a first example, the interior side walls, back wall (at or adjacent the center line of the trailer) and the door are affixed with sponge polymer bumpers, inflatable dunnage bags, springs, solid but resilient bumpers, or the like, which snug the SMCs in place in the locker interior when the ramp/door is folded up and locked in position.

In the alternative, the locker side walls and door are configured or molded with internally projecting ribs or curved sections that provide the cushioning of the SMC. Thus, in this embodiment, the side walls of the locker, as viewed from the interior space, are configured with relatively wide convex zones, ribs or sections that flex and grip the side walls of the SMC when rolled into the locker. Closing the door/ramp, which also contains such a section, engages the SMC in the locker to secure it against movement during transit.

In addition, the ramp and the interior floor of the locker can contain guide tracks for the casters of the SMCs. These guide tracks are typically metal or high density polymer to provide good wear resistance yet smooth rolling. The ramp door is preferably attached to the bottom of the locker with one or more hinges, ranging from a full width piano-type hinge to a plurality of pin and eye type hinges. The lateral edges of the door and the front edges of the locker include mating, lockable hasps and eyes that receive heavy duty padlocks or other types of locks. The opening of the locker can be rimmed with a compressible seal element so that when the door/ramp is closed, the edges are sealed against infiltration of water and road grime, dirt and debris.

Note that each SMC has its own auditable locking system and a location tracking system, so that the security of shipment is not solely dependent on the locker locks. Of course, highly secure locks of the Medeco-type can be used on the lockers, if desired.

The mobile containers are “smart” cargo containers comprising secure (strong and lockable), sealable, auditable, pollable, and trackable, universal, “mini-pallet boxes” having casters to permit roll-away handling that are sized to fit through retail and office doorways (herein “Mobile Smart Containers”, abbreviated SMCs). Sophisticated electronic locks, sensors and alarms are provided in or on the SMCs, as well as one or more RF communications and GPS locator module(s) that “radios” to a base station the time, location and status of the SMC, and any anomalous events as occurred, including unauthorized attempts to open or break into the container, or potential damage events such as fire, exposure to high temperature, radiation, biological contaminants, unauthorized movement, shock and the like. In addition, both the locks and communication modules are programmable, and provide extensive, and selectably pollable and downloadable event, access and transport history and audit trails. The communication system permits remote tracking and real time status check via the RF cell tower network to IPSec and thence to customer VPN or Frame Relay, and includes GPRS/EDGE encryption. The customer may internally distribute via its VPN, LAN or WAN, or wireless networks. The preferred communication system employs RF broadcast of encrypted data to remote control and monitoring site via one or more cellular telephone cell tower network(s) as a virtual private network. With respect to location, when no GPS fix is possible (the GPS antenna must “see” the sky), the location is provided by Relative Signal Strength Index monitoring from individual cell tower locations to obtain range and direction information to provide location data on the broadcasting SMC. In densely populated areas, where towers are typically a mile or so apart, the location accuracy is quite good.

The lockers may be constructed in a wide range of configurations and materials. In one embodiment, the lockers are made of tough, high density polymer, such as HDPE, composite materials, laminates of multiple layers of metal or metal and plastic, or made of sheet metal, such as steel, stainless steel, high grade aluminum, such as 7075 or 7075- An aircraft aluminum, or may be mesh cages. The solid walled lockers are preferred to maintain the cleanliness of the SMCs are wheeled directly from the truck into the receiving area of a hospital, clinic or pharmacy, so accumulated road dirt and grime would not be acceptable. Accordingly, the system also includes door seals for the locker to prevent infiltration of dirt, dust, road debris and water during transit. In addition, it is preferred to use a double-walled locker container configuration in which 1-2″ foamed-in-place urethane foam insulation is provided for both strength and insulation.

By way of example, the 4-caster SMC containers are typically rectangular, having exemplary dimensions on the order of 40″ long×22″-33″ wide×29″-33″ high outside dimensions and 37¼″×19″-30″×25%″ inside dimensions, at a weight of 140-160 lbs. These dimensions permit the SMCs to fit through a standard entry/exit doorway opening of 28-36″ width. However, it should be understood that the SMCs may be square, or smaller rectangles, e.g., the Courier size having two corner wheels and a telescoping handle. The size has typical dimensions of: 22.5-29″×17.5-18″×11.5-13′ and inside dimensions of 20-17″×16.5-17″×10.5-12.5″ at a weight of 35-45 lbs. An important feature of the SMCs is the provision of bottom-mounted wheels, either four corner-casters (standard SMC) or two fixed wheels (the smaller Courier size), that permit the SMCs to be loaded in the factory or office, rolled out and up ramps directly into the truck locker at the loading end, and permit the reverse movement at the destination end of the transit.

Each SMC, being less than a pallet-load in size, may be loaded with ethicals/controlled drugs at the pharmaceutical manufacturer, sealed and locked. The embedded tracking system is initialized. The electronic lock captures the dates and times of opening and closing, and permits those actions only by means of authorized keys. The audit trail also logs attempts to open by un-authorized keys, and can send alert messages in case of detection of anomalous events. Each SMC includes an electronics package that has various condition sensors and RF transceiver that radios out to the virtual private network its location and internal state.

Thus, together, the trackable location and call-home functionalities, the lock auditing and condition sensors of the embedded electronics package in the SMC and locker system comprise a multi-layered intelligence system. It provides Monitoring, Tracking and Mitigation of condition, location and anomalous events, as well as a verifiable audit trail of all handling events. The result is total assurance of purity of ethicals/controlled drugs and biologicals shipped via the SMC/locker system.

In addition, the SMC electronics package includes an RF tag reader, preferably using a communications protocol, such as a protocol like the 802.15.4 low level communications protocol, to read 13.6 MHz (HF) passive chips (tags), or/and 2-6 GHz active chips that are emplaced on products or packages loaded into the SMC for secure shipment. 900 MHz UHF passive tags are not preferred under the scope of this invention, as such frequency may adversely affect biologicals, and the reader for such tags require high drain power sources (power hogs). In the case of 2.4 GHz active tags, the ethicals or biologicals may be placed in metallized bags or totes, that is plastic (such as a plastic tote) that has been coated with a fine layer of metal (such as aluminum) to serve as a screen against the RF signal to prevent any damage to the contents. However, such metallized bag/tote packaging can be used universally, that is in all cases, just to insure no RF effect on the contents. For most ethicals/controlled drugs packed in the SMC, the HF tags are used at the product level or the package level, and the reader of the electronics package of the SMC can read the tags as the products are loaded and unloaded. Likewise, the active 2-6 GHz tags are preferable for use with biologicals, 2.4-5 GHz being presently considered the best mode, particularly when packaged in the aluminized RF-protective bags or totes. The frequency of the transmission is selected in a range so as to not affect the biologicals, particularly when packed in the RF-protective bags or totes, defined herein generally as to not be a substantial resonant frequency of hydroxyl or amine radicals at the power levels employed, as measured in the bags or tote containers. The active tags employ an RF transmitter and battery in a unit the size of a key fob.

In the preferred embodiment, each SMC is loaded with on the order of 4-8 totes, which are closable trays having side walls and lids for containing product or biological specimens. Each tote has its uniquely identified, addressable active 2-6 GHz RF tag. As the totes are placed into the SMC the reader of the electronics package detects (over a range of 20-50′ depending on antennas configuration, length and location) each tote and records the load or unload to memory. The same occurs for the HF tagged products or totes, however that is short range, on the order of 1-2′, again depending on the antenna configuration. The tags are preferably codes to match the EPCIS system, that is, the Electronic Product Code Information System used to track drugs and share inventory data with manufacturers, law enforcement and regulators. Together the passive HF or active RF tags reader is able to provide a load/unload log; in short, it provides an inventory log. Paired with the location data, and the key identification and authorization data and time, a complete picture of the who, when, where and what is recorded and relayed via the RF virtual private network in essentially real time to shippers, customers, auditors, tracking control authorities and the like, as appropriate.

The 4-caster mini-pallet box SMC embodiment includes hinged, L-shaped, flanged lock plate that covers the opening side of the SMC lid. In this first embodiment, the lock plate covers a housing for an electronic lock when raised, the lock plate completely covers the lock body, and includes a latch plate with a hole that engages the plunger of the electronic lock. In addition, the lock plate, when closed, covers a pair of spaced cam or snap type lid locks. The cam locks enable the lid to be cinched down, hermetically sealing the lid to the box. The cam locks are also completely covered by the flanged lock cover plate. Thus, to resist tampering; there are no exposed parts that act as a purchase for a pry bar.

In a second embodiment, a smaller, Courier size container having only 2 wheels and a telescoping handle in a configuration akin to a large roll-away suitcase, may be used for smaller shipments. It also includes the electronics package and functionalities described herein. In this configuration, the L-shaped lock plate is hinged adjacent the side wall edge of the lid so that it folds down. The lock mechanism is contained in the lock plate, and a striker plate having a hole there-through to receive and engage the male lock shackle mechanism is secured to the side wall of the container. The striker plate includes the lock contacts to complete the electrical circuit to the lock electronics contained in the electronics package inside the courier container.

In both container embodiments, the preferred lock system is a hardened electronic lock mechanism that permits identification of which “keyholder” (approved access-person or organization) opens the lock(s), when the lock(s) is/are opened, and how long the lock(s) stay opened, and, optionally, the location. The locks are hardened with steel shell, bolt and plug face. Each key and lock is uniquely identified, and there are virtually unlimited unique lock codes. The open/close time parameters can be pre-set, actual opening and closing times are recorded and downloadable, either by direct connection of the key to a PC, or by connection of the box lock to a hand-held device, such as a PDA, or the openings/closings can be radioed to a remote, home base. Thus if there is an attempt to open that is outside the authorized time, an alert can be radioed to a monitoring station service facility or service provider. By way of example, a suitable electronic lock is the NexGen high security electronic lock, Model 65 series, or Pal-Loc model, provided by Medeco Inc. of Salem, Va., USA, a division of Hillenbrandt Industries, Inc.

The locks and keys are uniquely identified, mating and programmable, including both at a home base and in the field, and store several thousand downloadable access events to provide a full audit trail. The programming includes configuring the key to authorize its use to open one or more boxes, to select the time, and by integration with the RF transmitter, controller and GPS module in the box, the location at which the box can be opened or/and locked. Thus, the boxes can be both authorized-entry/unlock and destination restricted to prevent unauthorized keys or persons from opening and closing the container.

Each of the pallet boxes are integrated (complete), and highly tamper resistant. That is, there are no loose parts that can be lost during use or storage, and the material is selected for strength to resist both casual and relatively concerted theft attempts. The lock is integrated in the exoskeleton, the top is flex-pry resistant, and the communication module includes location and links to sensor systems associated with the box (embedded into, secured onto, or disposed in the box cargo volume) to provide real-time state-of-the-container data.

The SMC and Courier containers each have a lid that is configured with a mating lip groove and rib to prevent insertion of tools or unauthorized inspection devices. The lid lip is preferably provided with a substantially hermetic seal element, for weather tightness, security and to assist in gas sampling evaluation of content integrity. This feature provides security for the shipper and is of great benefit for shipping products requiring integrity and/or security, such as ethical pharmaceuticals, biologicals and other contents requiring high-security due to their nature or the sensitivity of informational content. In combination with the lip seals, a port is optionally provided for evacuation of the container, or purging of the container with an anti-microbial or anti-pathogen gas, or pressurized with a security gas (which may include an anti-pathogen gas) to protect or sample the contents, or to expose a thief to a lethal or sub-lethal, incapacitating or marking gas or other fluid upon unauthorized breach of the box walls or attempts to pry open the box.

The single or multiple gas port system is also particularly useful for evaluating the contents of the box. Thus, the box may be pressurized at the departure point, and the pressure checked via the port valve (preferably a quick-disconnect type female union) at the delivery end. Substantial variation in pressure may indicate in-transit loss of integrity, breach, or some change in contents. In addition, a sample of the atmosphere in the box can be obtained by withdrawal of the internal gas. In still another process embodiment, an inert gas can be introduced into one port, for example a secondary, inlet port on the lower left rear side of the box, and a sample of the gas withdrawn from the primary port on the upper front face of the box. The inert gas can carry with it any entrained chemical vapor or bio-toxin signatures that can be analyzed by conventional chemical tests, or, in the field, with hand-held micro-channel reactant or electro-chemical sensor units. Thus, if an explosive charge or bio-hazardous material has been introduced into the box, say in a package or piece of mail packed in the box without knowledge of the shipper or mover, sampling the inert entraining gas provides a warning of the contents problem and the entire box handled appropriately to suppress or destroy the hazardous material without un-aware opening of the box.

The box may also be provided with a battery/condenser system so that an unauthorized person is shocked with high voltage upon attempts to open the box.

As the SMC/Courier containers are locked and the integrity verifiable, the SMC/Courier containers can be securely left at the receiving loading dock or warehouse for storage until the customer arrives to receive the goods. Indeed, the SMC/Courier containers permit elimination of shipping cartons, with the goods being unpacked directly out of the containers. This reduces the carton cost, the carton packing cost, and the carton volume and weight. Indeed, in view of the robust construction and high strength of the materials of the SMC heavy, wooden crating can be eliminated. Thus, high value and fragile goods can be securely moved in the SMCs and the crate-related costs eliminated.

Another common and accepted form of transit loss that the invention reduces is transit damage loss. The robust, rigid and reinforced, integral container substantially and significantly reduces the instance of real transit damage, as well as potentially allowing shippers to lower their thresh-hold for damaged goods claims of the automatic allowance category.

In connection with tracking and enhanced security, each SMC is provided with a sensing and communications module comprising sensors, controller, RF transceiver, GPS locator unit, battery and trickle charger. The sensors are distributed through the box or located in the electronics package, and optionally include an intrusion sensor system, such as a shock, breach or vibration sensor that is connected to, or in wireless contact with the controller to provide a silent or audible alarm. In one embodiment, the intrusion sensor comprises a liner-type insert comprising a conductive screen mesh adhered to the outside of a thin, rigid sheet (of ABS plastic, for example) that is electrically connected to the controller.

The preferred intrusion sensor is the emplacement of a vibration sensor in the electronics package, or on one or more walls, top and/or bottom to detect penetration attempts. In this connection, the SMC or Courier container includes external exoskeleton at least on the top lid, and optionally on one or more of the side walls and bottom. It is preferred, at least in the Courier size SMC container to include a laminated armor sheeting of expanded metal gridwork bonded between two sheets of plastic as an insert retained adjacent the inner back and short-side end walls. If desired a laminate sheet can also be included on the bottom, or/and between the front side wall inner side and the electronics package placed adjacent thereto. That is, an armor sheet can be used between the electronics package and the inner wall of the container to which it is secured. However, for the Courier SMC it is not absolutely required to have the expanded metal laminate armor sheet on the bottom or between the electronics package and the inside adjacent wall as the vibration sensor would be easily triggered by attempts to break into the container through those walls, first, due to the proximity of the sensor to the front wall, and second because of the presence of the handle assembly molded into the bottom wall. The extra assembly materials make intrusion through the bottom less likely.

Other sensors that may be disposed in the box or in association with one of the side walls, top or bottom walls include ultra-short range battery-powered RF or hard wired sensors that report internal or external sensed condition data to the controller. The sensors can trigger alerts and alarms, e.g., audible or silent, such as warning horns or RF transmission alert of a breach attempt, or movement of the box out of a predetermined transport path or location (linked to a GPS unit in the box). The GPS unit or the cell RSSI inputs location data to the controller which sends out data burst transmissions on pager, cell phone or other network frequencies to relay stations or to one or more home base(s) for track and trace functionality. Instead of the breach screen or vibration sensor, one or more RF sensor(s) can be used to detect breaching of the container walls, top or bottom, such as an IR, US (UltraSound) or light detecting sensor that sends a signal to the controller if an aperture as small as a crack forms in any of the box walls.

Optionally, one or more still or video cameras can be installed in each pallet box for monitoring of opening or conditions inside the box during shipment. A battery-powered light source and flash chip can be supplied in association with the camera. The camera can be programmed to take an initial series of pictures once the lid is opened a preselected angle, and then one per second or few seconds up to one per minute or few minutes. The pictures are uploaded and transmitted to monitoring base.

Narcotics and explosives detection may be enabled with miniature reactive chemical sensors or electro-chemical sensors, such as a GE SteetLab unit. As above, a positive output can be linked to the controller for radioing an alert or in-box non-baseline, abnormal or anomalous condition.

The smart container data communication and management system includes sensors, locks, alerts, alarms, cameras, container “armed” status lights, data encoders, transmitters and/or transceivers, computer programs, data bases, and related equipment to enable activation, coding, decoding and use of the data communications system, including real time and past history display of status and location, and management and operation report generation. The SMC container monitoring and management electronic data communications system(s) include(s) container-mounted, fitted or embedded components, separate remote signal relays (towers and satellite), monitoring station components, and auxiliary equipment including locators (GPS ans RSSI locators) and locking systems. The home base monitoring station includes a computer system having a CPU in which is loaded data engine, display programs and web server or web browser programs to enable activation, operation and use by customers of the data system.

Each shipper, customer or other authorized tracker can access data on individual ones of the SMCs, totes, product items or groups of any of them, via a customer or user name and password on an SSL server webpage. The tracker can poll where the container is, and the location provided by the container's GPS/GSM/RSSI unit will be displayed on a map. In addition, in the case of an anomalous condition being sensed, such as: unauthorized unlocking; attempt at tampering, entry or opening of the container; unlocking at an improper location; sensing temperature, humidity, chemical conditions, unauthorized removal of product, removal of the wrong product or tote, and the like, the home base or web site system will wake up and emit an alarm, including audio, visual, sending of e-mails, faxes and phone calls, to a selected number and type of individual for response. The remote monitoring aspects of the invention provides a method for shippers, customers, and security/audit personnel to monitor from a single “home” base, many containers and totes simultaneously, the number ranging easily in the tens of thousands. Under the system, the tracking personnel can be notified and check when anomalous events occur and can have a complete, verifiable handling report for each SMC from empty before loading to empty upon unloading at its destination, and with confidence in the security of the container along the route, including in the transport vehicle (truck, ship, rail, aircraft), from its origination facility, warehouses or transfer depots along the way and to destination unload or storage.

The security system provides a unique identifier for each SMC and tote in the field that is radioed to home base when the container is first put in use. Each container is pre-configured at home base (e.g., home warehouse, customer or mover's facility, manufacturing facility or the like), or in the field, e.g., at the site of the move loading, via an RF tag or via the PIC program with a unique identification number or other data (name of customer, moving company, moving van ID, type of goods permitted to be shipped, etc), and its cycle of time for status reporting is pre-selected at that time. As described above, the RF Zigbee/Bluetooth-type protocol reader reads the passive HF or the active RF tags on totes or/and individual product items are loaded in the SMC and provides a load (and later, and unload) inventory that is mapped to the location, time, and authorized key that opened (and then closed) the SMC; photos of the individual are also of record.

After loading and close of the lid, upon locking it is initialized or enabled, and thereafter the container reports its status, the time, or/and location back to home base on the predetermined timed cycle, e.g., every half-hour, more frequently at night, less during the day, etc.), or to pollers (very short range, long-life battery powered microprocessor-controlled RF transmitters that are placed at various sites in the truck, in the lockers, around the warehouse, storage facility or customer location), or by readers (long range, 100′-1500′ depending on antenna) transceivers with the ability to receive and interpret the data from the container transponders, e.g., as the truck rolls by a road-side reader tower, and then forwarding this information by wired or wireless communication to a computer or computer network for real time location and status data retrieval from the containers). The program at home base displays a map from the map program with each SMC or group of totes located thereon with a unique icon, and the status can be indicated in text or change of icon, e.g., by animating the icon, changing color, flashing, change of text, combinations, and the like. In addition, an audio alert signal can be emitted on the computer speakers when the sensor(s) or lock detects an anomalous event or unauthorized, untimely, or wrong destination attempts to open the container occur.

The computer-based SMC/locker system permits complete management of the container security during transport, storage, loading and delivery, as a business, including communication via the Internet of container status and event reports, orders, billing, e-mail communications, and the like. The net result is that the features of the SMC/locker system permit true national and international shipping security capability, including user-friendly web-based operation, with capability to produce archival electronic and/or hard copy records of the entire loading, transport, warehousing, and unloading data, including a complete audit trail of opening/closing activity and location by date and time.

The controller/sensor/RF/RSSI/GPS units are included in an electronics package that is preferably secured to an inside wall of the SMC, or in other convenient location. Customs or other security wires and seal systems may also be used for international shipping compliance.

It is preferred to include a loud, 80-120 DB battery-powered audio alarm system in the SMC electronics package. Preferably the alarm noise-maker is disposed in the front wall of the container behind a speaker grille that is covered by the lock plate. This alarm is activated by simple magnetic or button type contact switch elements in the lid and top of the box wall, respectively, or may be connected to the intrusion sensor, such as the screen insert or vibration sensor described above. The switch which arms or turns the alarm off is hidden behind the electronic lock cover plate. After unlocking the cover plate, the switch is accessible and must be turned off within a limited time, say 5-10 seconds, so the top can be opened.

It one aspect of the present system, products (cargo)/totes are packaged with RFID-type tags (passive HF or active RF) embedded in them or in the packaging thereof. The tags are encoded with electronic product code (EPCIS) standard data at the unit, case and pallet levels during the product (e.g., pharmaceuticals, biologics and prescription drugs) packaging process. In an important aspect, of this invention, the SMC controller is provided with a sensor/reader that can read the HF/Active RF tags or Memory Spot Chips (MSCs from HP) of products are loaded into the SMC, and retain the data in memory. The RFID passive tags are short range (up to a few feet) low frequency (13.6 MHz) emitters. The SMC then can use the RF transmitter section of the electronics package to transmit a record of the tag EPCIS codes as loaded, or indeed, during the loading process, in essentially real time. If desired, the SMC can be polled in transit to verify the products loaded therein by the EPCIS codes as read at the time of loading. In the case of active RF tags at 2-5 GHZ frequencies, the RF sensor/reader can verify the products/totes loaded in the interior, and can transmit the data by RF signal to the cell tower VPN as requested. Upon arrival and authorized opening of the SMC, as the products are unloaded, the reader notes the removal, typically by signal strength reduction or signal loss (movement of the product out of range). This is also transferred to memory, and a concordat of load inventory vs unload inventory can be provided as part of the audit trail.

The load/unload EPCIS or RF tag serial number data also can be loaded into the memory of the electronic lock key (or and the lock itself), so that upon relocking of the SMC by the electronic key, the key has the comparative record of load vs unload inventory. In an extension of this load/unload audit, the receiving customer, e.g., a clinic or hospital may have RF sensor/readers at selected location(s) on site so that the physical location of the tagged ethical product or tote is tracked while on site. Thus, the clinic/hospital's drugs locker is fitted with a reader, and as the received products are placed into inventory, that on site reader adds the product to the local inventory. In addition, the drugs locker reader can relay the log-in data via short range RF, e.g., 3-6 GHz transmission, to the RF transceiver of the SMC, and the SMC in turn can act as a relay to the shipper or the ethical drugs supplier (pharmaceutical house), or suitable tracking authority (hospital, health care organization, HMO, drug agency, law enforcement agency, or the like) via its RF cell network VPN communications system. As withdrawals are made from the clinic/hospital's drug locker, the RF tag information may be read and relayed as described. Thus, the SMC system provides a secure and comprehensive product tracking with provision for full handling and audit trail records.

MSCs are miniature wireless chips that currently have a 4 MB capacity of flash memory; greater capacities will soon be available. In addition, while current RFID/MSCs are silicon based, organic, printed RFID/MSCs are close to commercialization, and such types are included within the broad scope of a “tagged” or otherwise identified package. Indeed, the invention includes the provision of a scanner associated with the SMC to read bar code that may be used to identify packages, and the package bar code IDs are scanned (read) as the packages are loaded and unloaded, with the data being used as described above, by way of example.

### BRIEF DESCRIPTION OF THE DRAWINGS

The invention is described in more detail with reference to the following drawings:

FIG. 1A is an isometric elevation view of a trailer-truck with the under-slung SMC lockers in position under the deck of the truck trailer; FIG. 1B is a vertical section in transverse elevation, of a trailer showing the back to back locker positioning under the trailer deck and the use of the locker door as a ramp for loading/un-loading.

FIG. 2A is an isometric view of a first embodiment of a locker with the side wall door open to show its use as a ramp, and a first embodiment of a sling assembly for securing the locker under the deck of the trailer of FIG. 1A/B; FIG. 2B is an isometric view of a second embodiment of a locker with a second embodiment of a sling system for securing under the deck of the trailer of FIG. 1A/B.

FIG. 3 is a photo, in isometric of an SMC container showing the casters for roll-away port-ability.

FIG. 4 is a vertical section, in longitudinal elevation showing the locker, a first embodiment of a truck deck hanger system and an SMC disposed interiorly of the locker with bumpers to prevent shifting during transport.

FIG. 5 is a vertical section, in longitudinal elevation showing the locker, a second embodiment of a truck deck hanger system, and an SMC disposed interiorly of the locker.

FIG. 6 is a front elevation of the locker of FIG. 2A showing the configured side-walls that flexibly act as retainers for the SMC when loaded.

FIG. 7A is a partial front elevation view of the SMC lid locking assembly with the flanged lock cover in the raised, locked position.

FIG. 7B is an isometric view of the SMC lid locking assembly showing the flanged lock cover in the lowered, unlocked position.

FIG. 7C is an isometric view of the front of the SMC showing a security gases inlet, gases purge, or vacuum exhaust line inserted in the quick-disconnect coupling on the front left of the container as seen in FIG. 7B.

FIG. 8A is an isometric view of the lid locking assembly showing the optional flexible weather cover in the lowered, open position.

FIG. 8B is an isometric view from the interior of the lid lock in its housing engaging the latch plate in the locked position.

FIG. 9 is an isometric of the body interior reinforcing plates bolted through the box walls to secure front and back end wall exoskeleton panels and showing the electronics for the “smart” functionality of the box.

FIG. 10A is an isometric, partly exploded view of the interior of the smart cargo container showing insertion and placement of the optional side walls security screen(s);

FIG. 10B is a section view along lines 10B-10B of FIG. 10A of the optional H-connector that retains the interior security screen panel(s).

FIG. 11A is an isometric of the electronic key inserted in the lock aperture (keyway).

FIG. 11B is an isometric of the electronic key inserted in the lock assembly, and rotated into the “open” position to release the lock plunger.

FIG. 11C is an isometric of the lock popped open upon turning the key as in FIG. 11B.

FIG. 11D is an isometric of the programmable electronic key showing the electrical contacts that engage the lock.

FIG. 11E is an isometric of the hardware for configuring use authorizations and audit trail downloads of the electronic key with the SMC container system.

FIG. 12A is a schematic block diagram of the architecture of the controller and data communications system as employed in the SMC.

FIG. 12B is a schematic of the system and operational architecture of the remote electronic tracking and security reporting by the SMC transport system while en-route in a trailer locker.

FIG. 13A-D are a series of photos showing the Courier container configuration of the SMC, in which FIG. 13A is an isometric of the closed SMC from the front, lower side; FIG. 13B is an isometric of the insertion of the electronic key into the electronic lock receiver in the lock plate; FIG. 13C is an isometric of the lock plate opened and the lid latches released; and FIG. 13D is an isometric photo of the Courier SMC with the telescoping handle extended.

FIG. 14 is a photo of the internal electronics module with typical components.

FIG. 15 is an isometric schematic, partly cut away of an SMC showing the loading of totes.

FIG. 16 is a block diagram of an exemplary configuration of the electronics package of the SMC containers of this invention.

### DETAILED DESCRIPTION

The following detailed description illustrates the invention by way of example, not by way of limitation of the scope, equivalents or principles of the invention. This description will clearly enable one skilled in the art to make and use the invention, and describes several embodiments, adaptations, variations, alternatives and uses of the invention, including what is presently believed to be the best modes of carrying out the invention.

In this regard, the invention is illustrated in the several figures, and is of sufficient complexity that the many parts, interrelationships, and sub-combinations thereof simply cannot be fully illustrated in a single patent-type drawing. For clarity and conciseness, several of the drawings show in schematic, or omit, parts that are not essential in that drawing to a description of a particular feature, aspect or principle of the invention being disclosed. Thus, the best mode embodiment of one feature may be shown in one drawing, and the best mode of another feature will be called out in another drawing.

All publications, patents and applications cited in this specification are herein incorporated by reference as if each individual publication, patent or application had been expressly stated to be incorporated by reference.

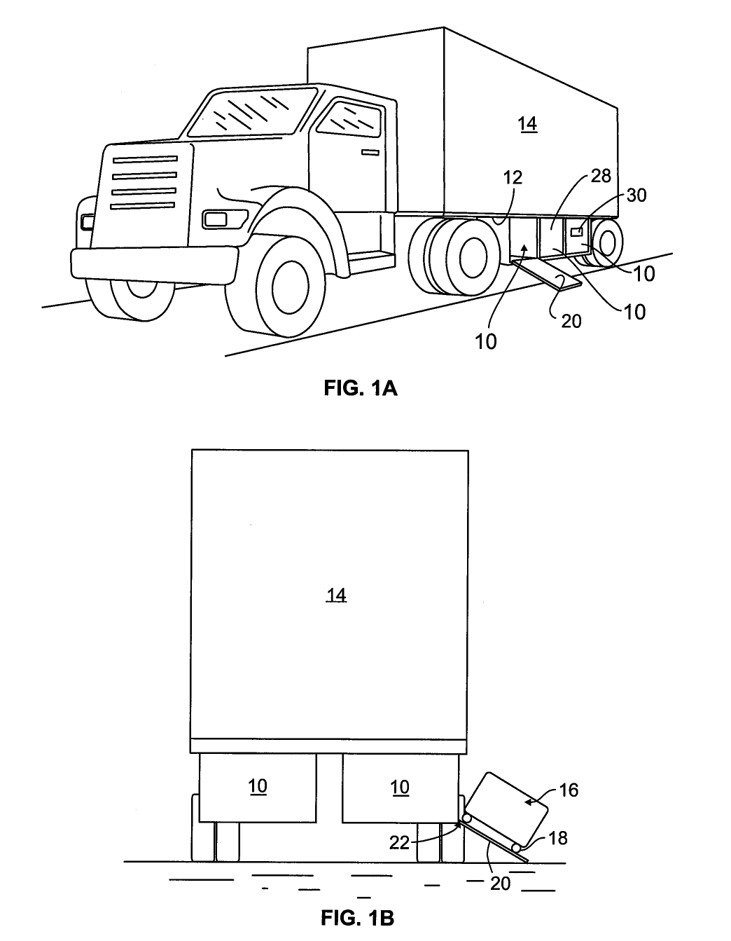

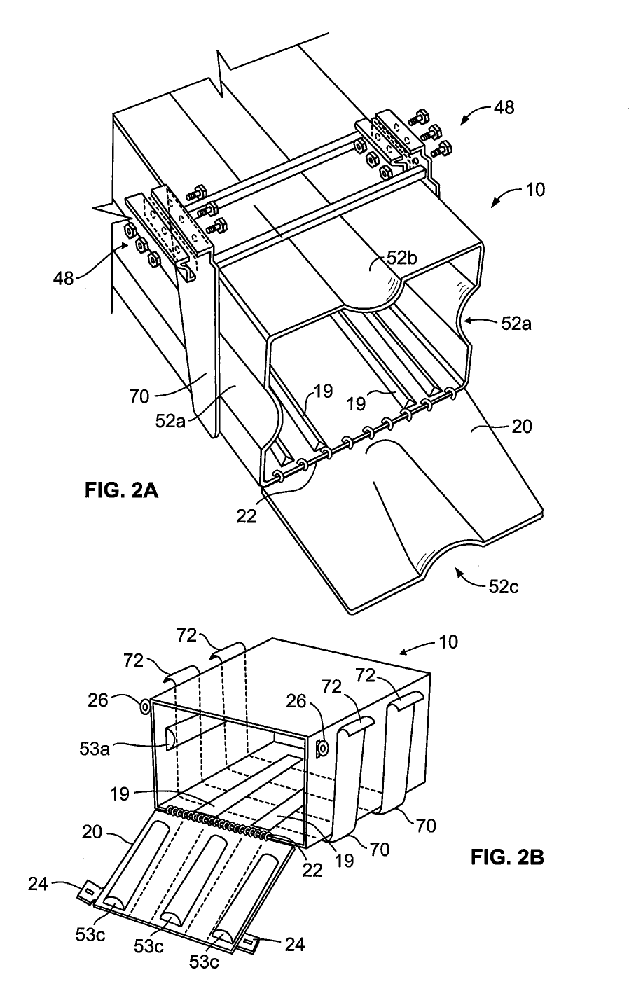

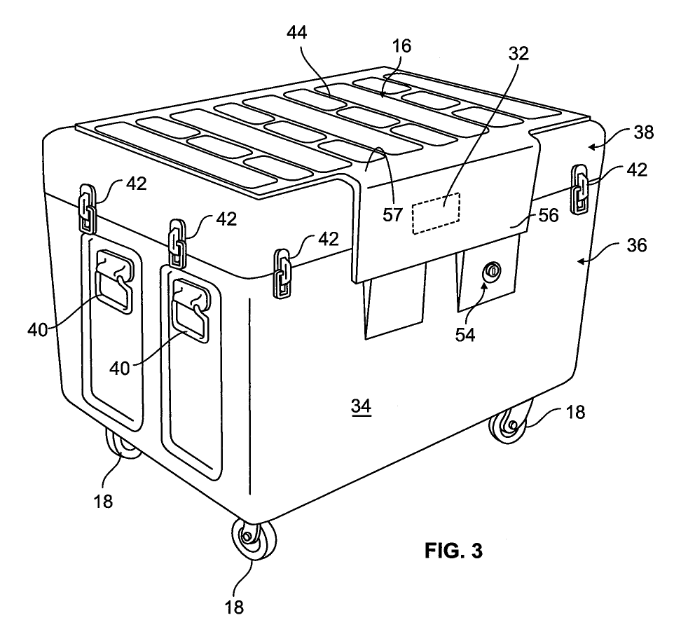

FIGS. 1-3 show the under-slung lockers 10 mounted under the deck 12 of a truck trailer 14. The lockers 10 receive SMCs 16 (FIGS. 1A and 3) that include 4 casters 18 for roll-away portability. As best seen in FIGS. 1 and 2, the front wall 20 of the locker folds down by hinges 22 to form a loading/unloading ramp.

As seen in FIG. 3 the SMCs are packed, typically by the supplier or authorized distributor in the case of ethicals, and locked at the point of origination, and then are loaded in the lockers. The front wall 20, which forms the ramp and entry door, is raised and locked, being secured by heavy duty padlocks or other secure locking system, e.g., at hasp and eyes 24, 26 (FIG. 2B).

Each locker has an identifying position location or serial number that codes the locker position on each trailer. A useful system is to bar code the lockers on the exterior visible face 28 in a position 30 that can be read while the truck is moving by a road-side or dock-side mounted scanner. Likewise each SMC 16 can include, in a predetermined location 32 (FIG. 3) on one or more faces, a unique serial number in any convenient format, such as bar code. Of course the contents of each SMC are known at the time of loading. Thus, an initial audit “start” status, comprising the SMC by container and its location on a particular trailer, and location in a particular locker of the trailer are known by their serial/location numbers. If desired, the towing tractor may also have an ID, and the one or more drivers can be similarly provided with ID indicia.

The individual SMCs 16 are shipped and tracked by the freight line to the destination location. In accord with the present system, each SMC has a unique ship-to destination, say a rural clinic. Upon arrival, only the unique locker containing that SMC is unlocked, the SMC is unloaded. There the SMC is unlocked by the customer or other recipient having an authorized key, for unpacking and logging into the customer's inventory, the SMC having been certifiably maintained segregated from other ethicals in other SMCs and from general merchandise on the interior of the traier. In addition the SMC has been certifiably and verifiably secured and tracked throughout the entire transport sequence. A print-out of both the SMC lock/unlock audit trail and of the transportation track (route) may be provided as part of a service of the shipper providing certification of segregation and security, either for the supplier company internal management control and review, or for the customer as part of a “comfort” and proof of handling verification service.

By way of example, the SMC 16 as shown in FIGS. 1B and 3 may be any convenient size for transport of regulated or high value products. Preferably the SMC containers are typically rectangular, having exemplary dimensions on the order of 40″ long×22″-33″ wide×33″ high outside dimensions and 37¼″×19″-30″×25½″ inside dimensions. These dimensions permit the SMC containers to fit through a standard office entry/exit doorway opening of 26″-36″ width. Since many interior doors range from 24-32″ wide, a preferred width dimension of about 28″ also permits the SMCs to be wheeled directly into most rooms. Some rooms are accessible only through 24″, 26″, 28″ or 30″ wide openings, in which case, as needed, SMCs having an external width dimension of less than 28″ can easily be provided by adjustment of the container size. This preferred configuration is approximately a half standard pallet, so that one SMC placed front face to back or front face of a second SMC fit in the footprint of a standard pallet. However, it should be understood that the SMCs may be square, or smaller rectangles, e.g., ¼ standard pallet sized.

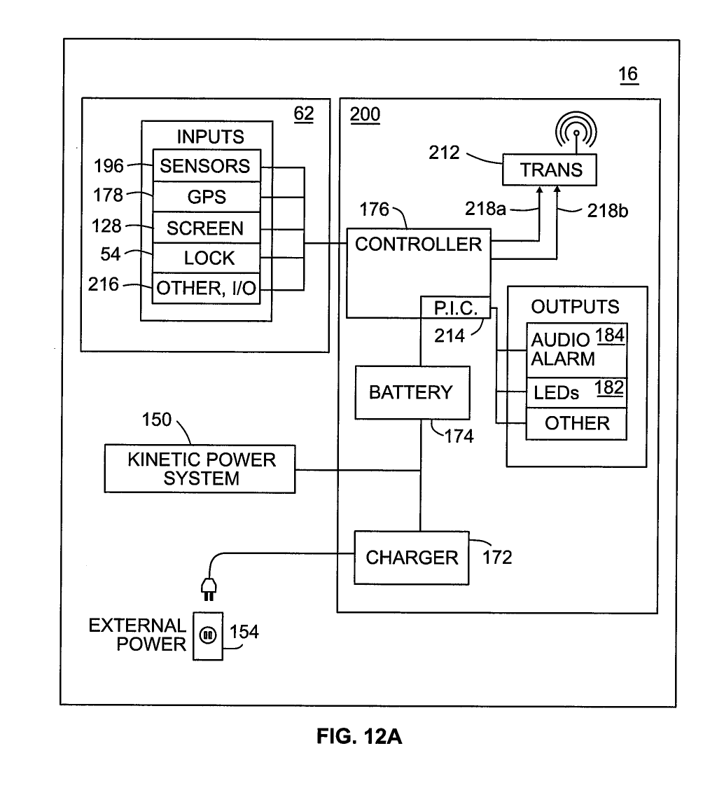

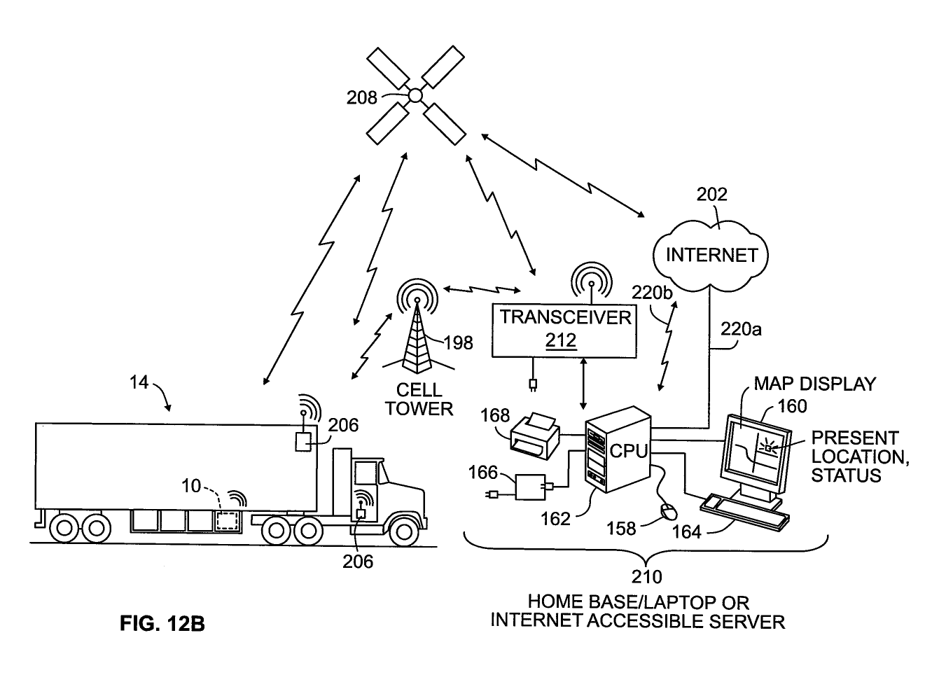

The presently preferred configuration of the SMC 16 comprises a molded polyethylene, e.g., HDPE, container body 36 and lid 38, and includes water resistant neoprene seal on the inner periphery of the lid, a stainless steel exoskeleoton 44 and a set of 4-5″ polyurethane casters 18, two that lock and two that swivel. The presently preferred exterior dimension is 42¾×30¾×29¼″, the interior is 39¾×30¾×20½″; the lid thickness is approximately 5″. The body 36 may optionally include fold-down handles 40 on each side. With the casters, the top of the SMC is about 36″ above the floor. A preferred electronic security lock system 54 is disposed on the front side 34, and the lid 38 is prevented from opening by a flanged lock cover 56. The sealing of the lid to the body is assisted by latches on the sides and front by latches 42. The presently preferred electronic lock 54 is a Nexgen stainless steel lock by Medeco. The tracking electronics (see FIGS. 9 and 12A) employs quad band RI GPS using GPRS/CDMA/SMS for communication by a Virtual Private Network over cellular telephone network towers (e.g. GSM/GPRS/GDGE) and an optional Global Satellite Communication unit. The tracking and sensor monitoring as done with a GIS Internet Software System. The internal, in-transit and in-storage power is provided by a rechargeable 18 Amp-hr, 12 V battery pack and includes a charger having a transformer for connection to a 120V source. The sensor pack includes IR, motion/G-force, temperature and an optional photo-sensor.

An important feature of the SMC is the provision of bottom mounted casters 18 that permit the SMCs to be loaded in any convenient location, rolled out and up the locker ramp, without dismounting of the locker from the trailer, and permit the reverse movement at the destination end of the shipment, and that this can occur without having to go into the trailer interior and sort through general goods to locate those that must be segregated.

It is an important feature of the system and method aspects of the invention that the SMCs are loaded and locked at the origination end directly in the supplier factory or packing facility, and not unlocked until arrival at the authorized buyer's location for unloading. Audit and tracking, optionally including condition status monitoring and/or location polling, that are verifiable by the supplier(s) and customer(s) are key features of the present system and method. Optionally, an archival record can be printed for confirmation of the container access and trip route integrity of the transport process. The customer gains an immense sense of security when it has an authorized person lock the SMC at point of origin (e.g., ethical pharmaceutical house), personally keeps custody of the authorization-to-open key for the duration of the transport, and personally unlocks the container at the destination clinic or hospital. In addition, the RFID/MSC inventory tracking is an important optional feature of the invention.

The SMC containers of FIG. 3 are robust. By way of example, the SMC containers are constructed of any high strength material, and are preferably unitary, double walled with foamed in place urethane insulation between inner and outer layers. Preferred container materials include: high density polyethylene or polypropylene, or copolymers thereof; steel; aluminum; fiberglass; high strength homo-polymers or copolymers; composites; laminated or reinforced polymers (such as carbon, Nomex, Kevlar, and/or glass fiber reinforced polymers); high-density co-molded polyolyfins; polyolefin and aluminum or steel honeycomb or corrugated (sinusoidal or angular in shape) laminates, such as polyolefin skins/aluminum honeycomb/corrugated core laminates, multi-layer woven fiber or fabric and aluminum sheet sandwich laminates; or any other available suitable rugged material, available at the present or in the future. It is preferred that an SMC is capable of carrying substantial loads, and is capable of withstanding the weight of at least two additional fully-loaded SMCs stacked on top of it, although stacking is not a preferred mode of transport or storage.

In the preferred embodiment, as part of the robustness feature, the SMCs include an exterior reinforcement structure 44 of fabricated steel, titanium or other hardened metal alloy strips, termed an “exoskeleton”, that functions to provide: 1) structural reinforcement of the plastic lid, and optionally walls and floor; and 2) fortification of the box against unauthorized entry for security purposes. Metal “flat” or strapping criss-crosses the lid and optionally align with vertical straps, channels, or sheets along at least two opposed vertical sidewalls (preferably the front and back end walls) of the box. The vertical side wall straps, channels or sheets extend to wide strapping under the floor. A front side includes an electronic lock mechanism 54 that unlocks a hinged, flanged lock cover plate 56, that pivots either up or down, depending on the SMC container configuration.

By way of orientation terminology, the side of the SMC that includes the primary locking mechanism 54, 56 is called the front, which is on one of the long, 40″ sides in the preferred example. The back side is the opposite long side, and the hinge(s) for the single-piece top lid are located along the back side margin of the lid at the juncture with the back side wall. The respective right and left side walls are the short sides of the SMC, in the preferred example from 24″-33″ in length, the length being selected depending on the access door width of particular suppliers or customers that will use the SMCs. Of course, a size in the range of 28″-33″ is preferred, so that with the lock assembly on the front and the hinges on the back, there is clearance through doorways. That is, when the SMC is wheeled (4 casters or the 2 wheels of the Courier container configurations), the long axis of the box is oriented in the direction of travel, so that the front and back are now the “sides” facing the door frame as the box is wheeled through the doorway. The trailer lockers can be sized for the SMCs to be oriented with a side facing out, or the front 34 facing out. The side facing out is presently preferred, as that gives access to the handles 42 when the locker fold-down door/ramp 20 is opened.

A single panel, hinged top lid 38 is provided for the container, a set of hinges being located at the top of the rear wall. The lid in the open position rests in a generally vertical, but backwardly-canted position at the back of the container. The top is also armored with exoskeleton strapping 44 extending the longitudinal length of the lid and transversely across it. In addition, marginal vertical edge of the lid may optionally include a steel band for strength and security. The front of the lid includes a slotted tangs that are engaged by one or more cam-type locks 42 on the front and side walls adjacent the top. The locks can also be snap type. The underside of the lid includes a wide seal strip (not shown), such as a double seal of neoprene or other sealing material, adjacent and all around the margin that is aligned with the side walls top edges of the container body 36. Thus, when the top is latched and locked, the seal strip is compressed providing a substantially hermetic seal between the SMC top and side walls of the body. The underside of the lid typically includes an engineered array of reinforcing recesses.

Optionally, additional strapping extends down the sides and under the floor of the container body 36 for additional reinforcing and use-life. In this embodiment, the body strapping is provided in three panels, a front and a back that are hinged to a bottom panel at the front and back edges of the bottom panel. The front and back side wall straps can also optionally included hanger members (such as horizontal pins, inverted J-shaped flanges or hooks, or slotted box catches and the like) that can be engaged to lift or suspend the boxes. The optional steel flat or strapping on the front and back walls and bottom is typically ⅛″ thick stainless steel stock by 2-4″ wide. The top strapping 44 is typically 1-2″ wide stainless steel strapping ⅛″ thick.

The SMC employs four 4-5″ polyurethane and stainless steel casters 18, two fixed and two that swivel, at least two of which are lockable for maximum movability or stationary positioning, as needed. The Courier sized SMC employs two wheels spaced at corners of the juncture of the bottom wall and the left side wall. A telescoping pull handle is provided so the Courier container can be wheeled in the manner of a large roll-on luggage bag.

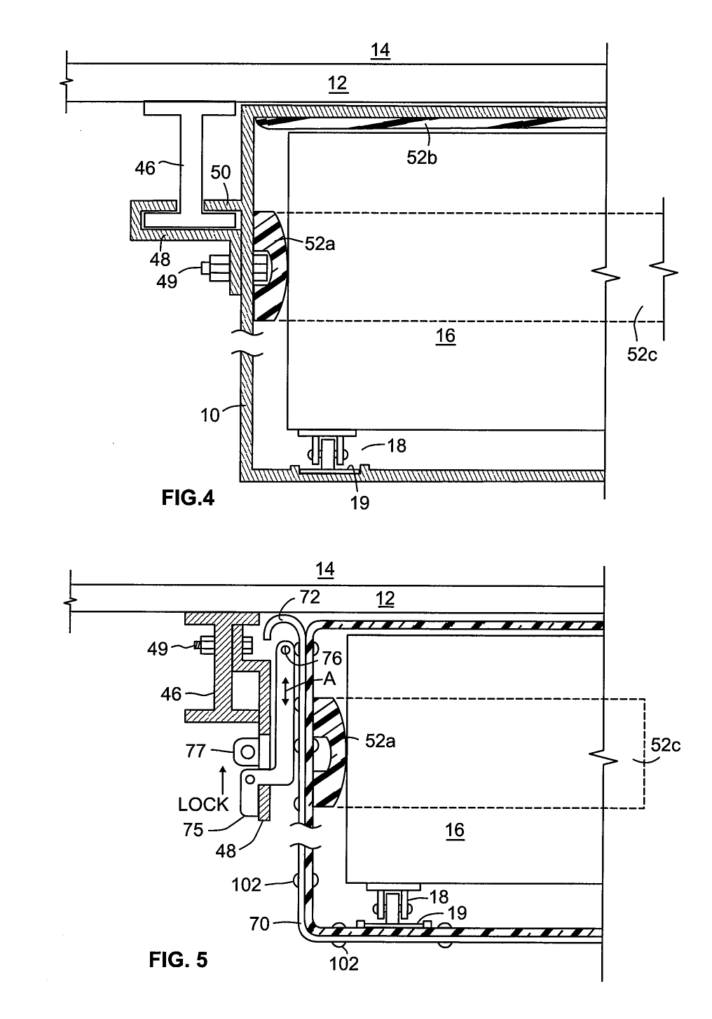

FIG. 4 shows a locker 10 secured by bracket 48 and flange 50 via bolt 49 to the flange of an I-beam 46 that forms the understructure of the deck 12 of the trailer 14. An SMC 16 is shown in travel position, having been rolled in place by casters 18. An optional wear plate 19 can be provided between ribs that act as guides for the SMC positioning into the locker 10. One or more bolsters 53 are preferably provided to prevent shifting, noise and wear during transit, and to provide cushioning. As shown side wall bolster 53a cooperate with ceiling bolster 53b and rear and front wall bolsters 53c (see FIG. 2B).

FIG. 5 shows a second embodiment of the locker suspension system; also refer to FIG. 2B. In this embodiment, the locker includes at least one U-shaped hanging steel strap(s) 70 along each side and under the bottom of the locker 10 that may be secured by rivets, welds, bolts or other fasteners, depending on the material of construction of the locker body, here shown as HDPE. The straps terminate at their top ends in an inverted J-hook 72. The securing bracket 48 is bolted directly to the I-beam 46 via through-bolts 49. The bracket includes a vertical slot in which is fitted a vertically slidable arm 75, the top of which includes a pin 76 for engaging the J-hook 72 when in the raised position. In that position, the hole in the arm and tang 77 align, and a securing pin (not shown to preserve clarity) inserted to secure the locker in position under the deck 12 of trailer 14. The pin includes a transverse hole for a retaining member such as a cotter pin or padlock shackle. Side and back bolsters 52a, 52c are shown, and this embodiment may also include ceiling and door bolsters.

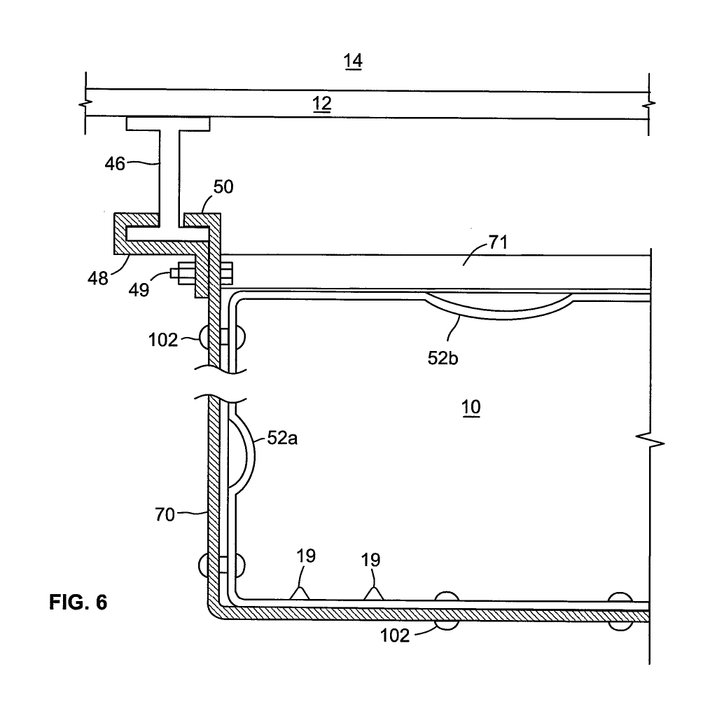

FIGS. 6 and 2A show a third embodiment of the locker suspension system, comprising U-shaped steel strap 70 to which the locker, here of HDPE is riveted or bolted. The locker side walls include inwardly formed bulges which act as bolsters, 52a-52c, as the plastic provides some flexibility, in this embodiment, being built into the configuration of the side walls and top of the locker 10. A steel cross member 71 maintains rigidity, while two spaced ribs define each caster guide track 19. The locker is preferably double walled with foamed in place urethane insulation between, typically 1-4″ of insulation. Connections to the truck refrigeration system for cooling and to the electrical system to power heaters embedded in or secured onto the inner walls of the locker are provided.

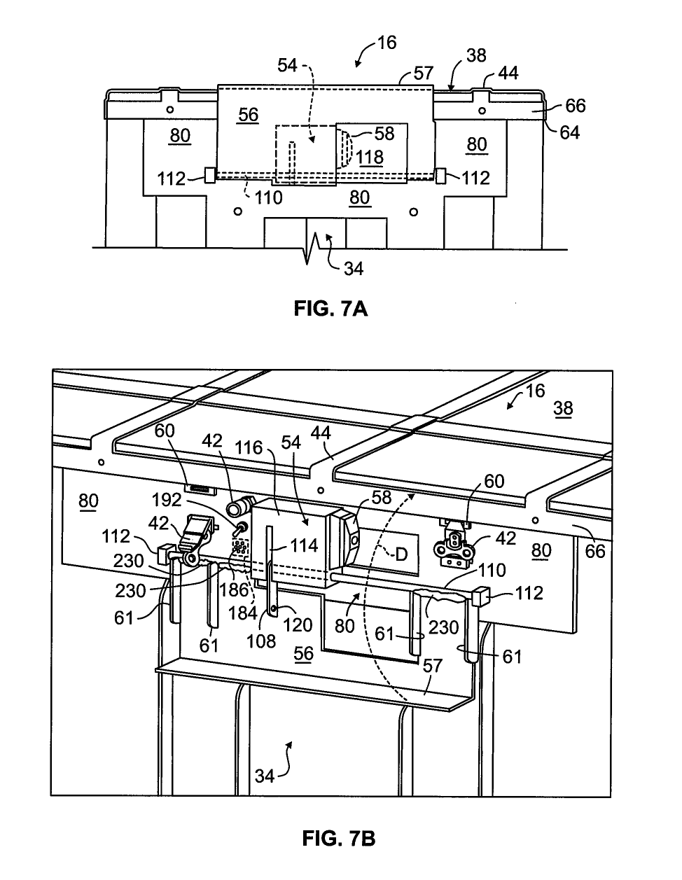

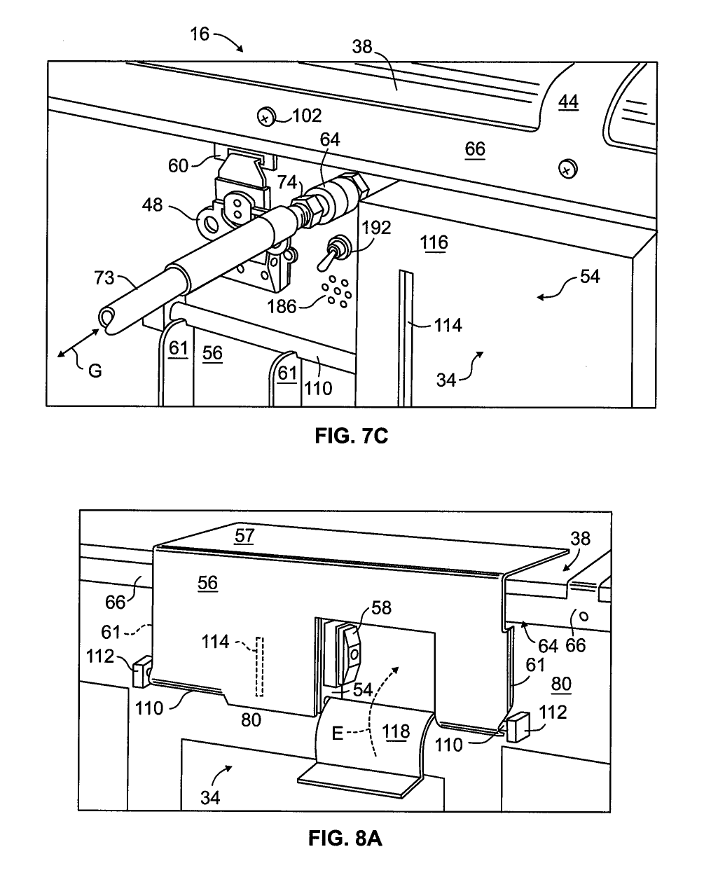

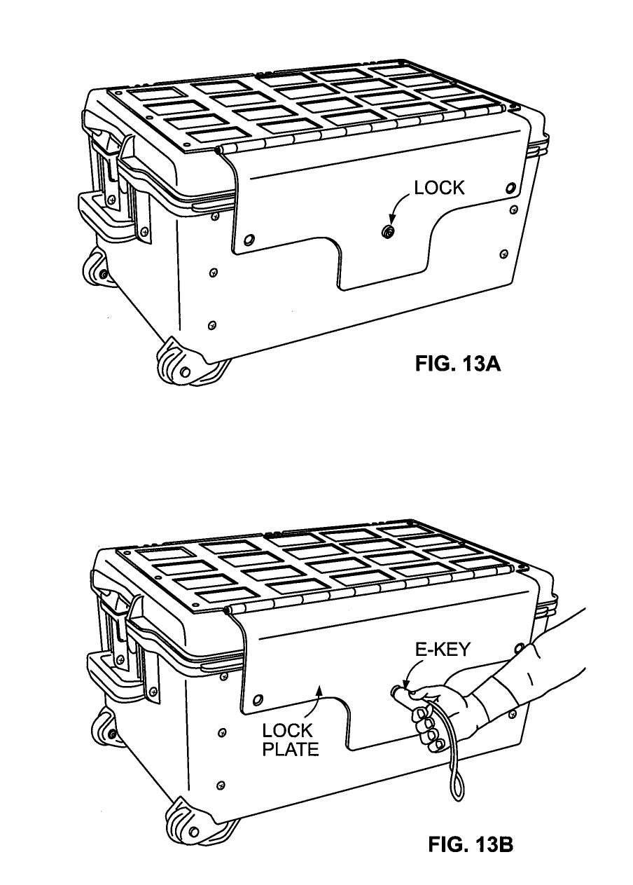

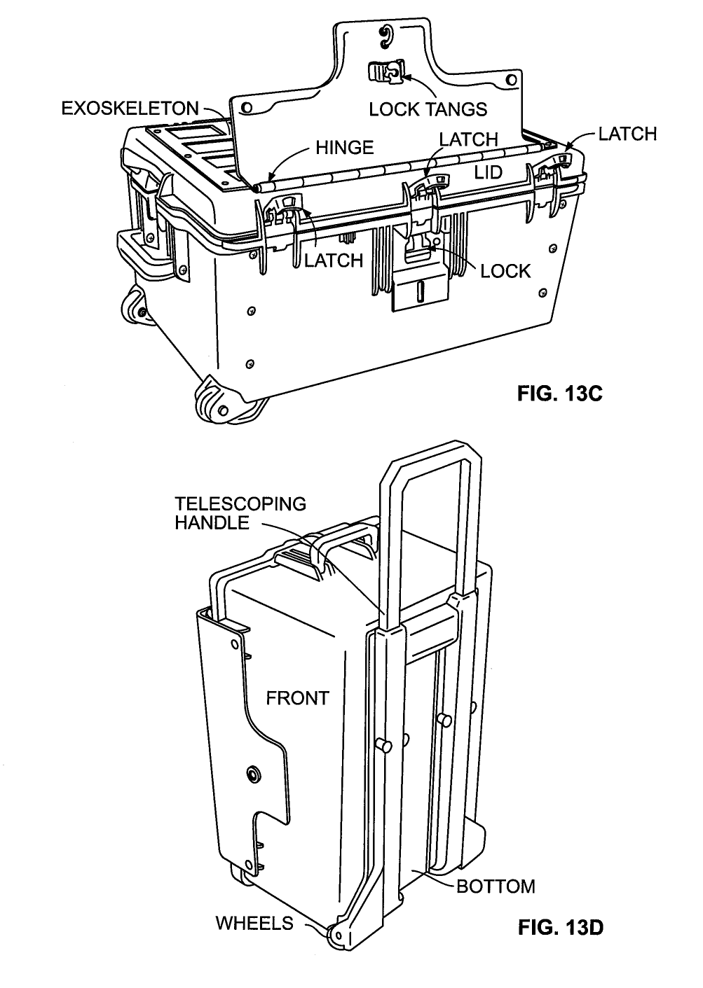

FIGS. 7A, 7B and 13A-13D are partial front views of the flanged lock cover 56 in the raised and lowered position, respectively. The top lid locking assembly 54 is welded or secured to the front face of the SMC; optionally the front face can include exoskeleton panel 80. Flanged lock cover 56 is welded to lock cover mounting rod 110, which rests in rod brackets 112, each of which brackets in turn is secured either to the SMC or to front exoskeleton panel 80. Lock cover 56 is raised in FIG. 7A so that flange 57 (best seen in FIGS. 3, 7B and 8A) extends up over lid lip 66 and lid 38 preventing access to electronic locking assembly 54 which can be clearly seen in FIG. 7B, which shows the lock exposed.

FIG. 7B is an isometric view of the lid locking assembly 54 showing the flanged lock cover 56 in the lowered, unlocked position, exposing lock housing 116. Arrow D shows the closing and opening path of flanged lock cover 56. Now visible are additional rotary cam-type lid latches 42 and the respective lid tangs 60, which, when engaged and rotated, cinch down lid 38, compressing the lid seal to the side walls of the SMC (not shown). Optional vertical flanges 61 form reinforcing channels in the lock cover 56, and secure both sides of each lid latch 48 against tampering.

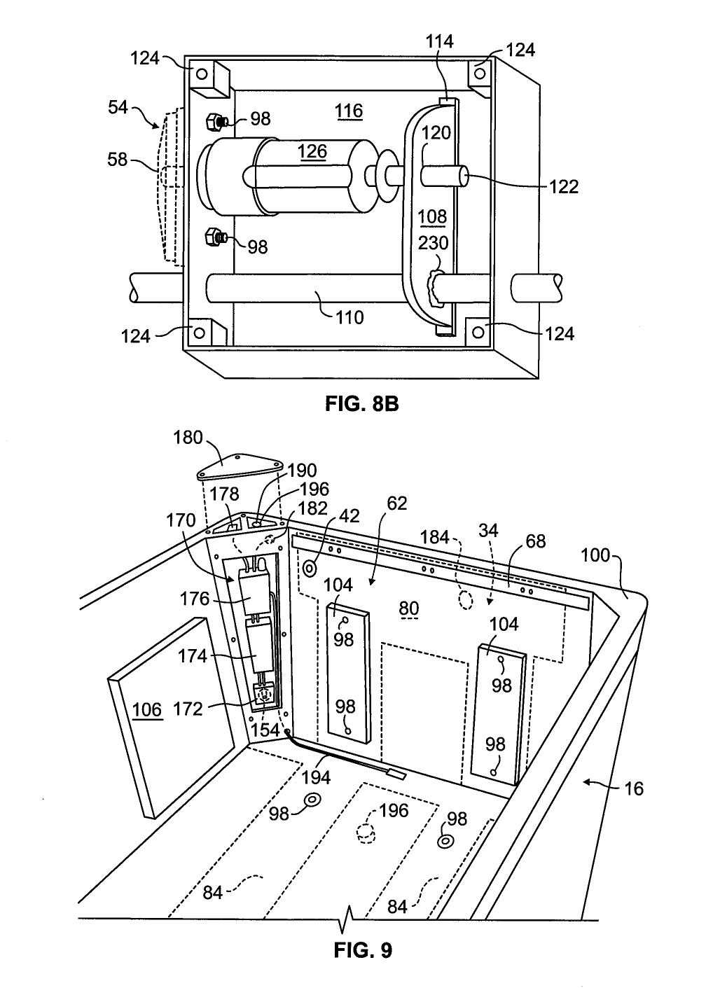

Latch plate 108, which is welded to the lock cover mounting rod 110 and the lock cover 56 is now in the down position. However, when it is raised, its hole 120 engages the locking pin or plunger 122 of lock body 126 (best seen in FIG. 8B).

FIG. 7C is an isometric of the left, front side of the SMC 16, showing the lid 38 closed with the cam latch 48 engaging and pulling down the lid 38 from which the lid latch tang 60 extends. Also seen is the optional lid perimeter strapping 66, one of the top exoskeleton straps 44, the housing cover 116 of the lock assembly 54 with the latch plate slot 114 exposed. The lock cover 56 is in the lowered position, being pivoted down on its mounting rod 110. The alarm speaker grille 186 and alarm switch 192 are shown between the lock housing 116 and the cam lock 42. Above the switch 192 is show a female, quick-disconnect type gases or fluid inlet port 64. Jacked into the inlet port 64 is a gases supply/evacuation hose 73, which terminates in the corresponding male quick-disconnect fitting 74. Gases can be inlet or withdrawn via the hose and couplings 64, 74 as indicated by the bi-directional arrow G.

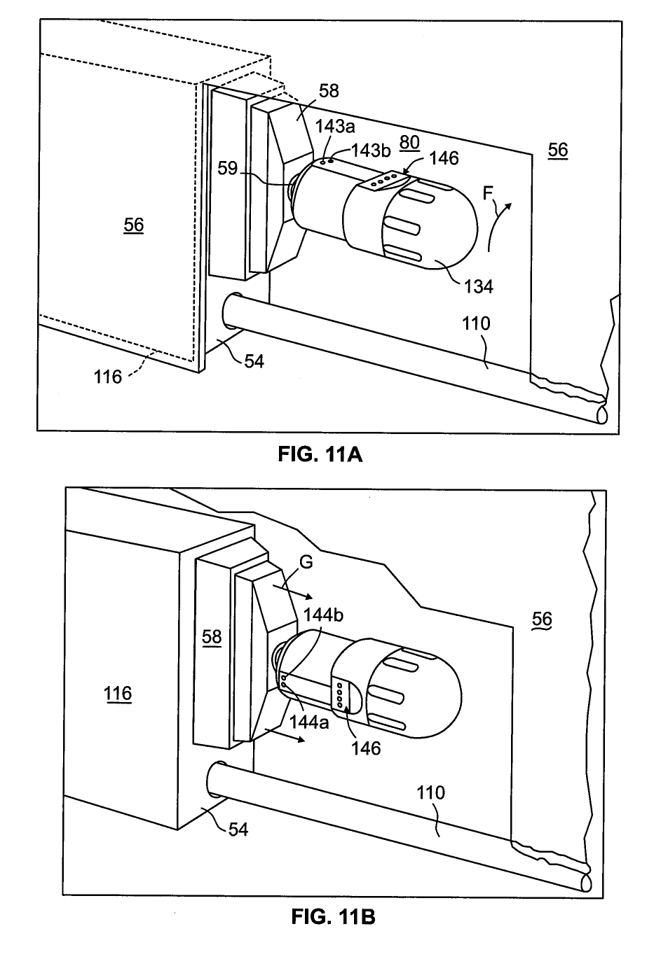

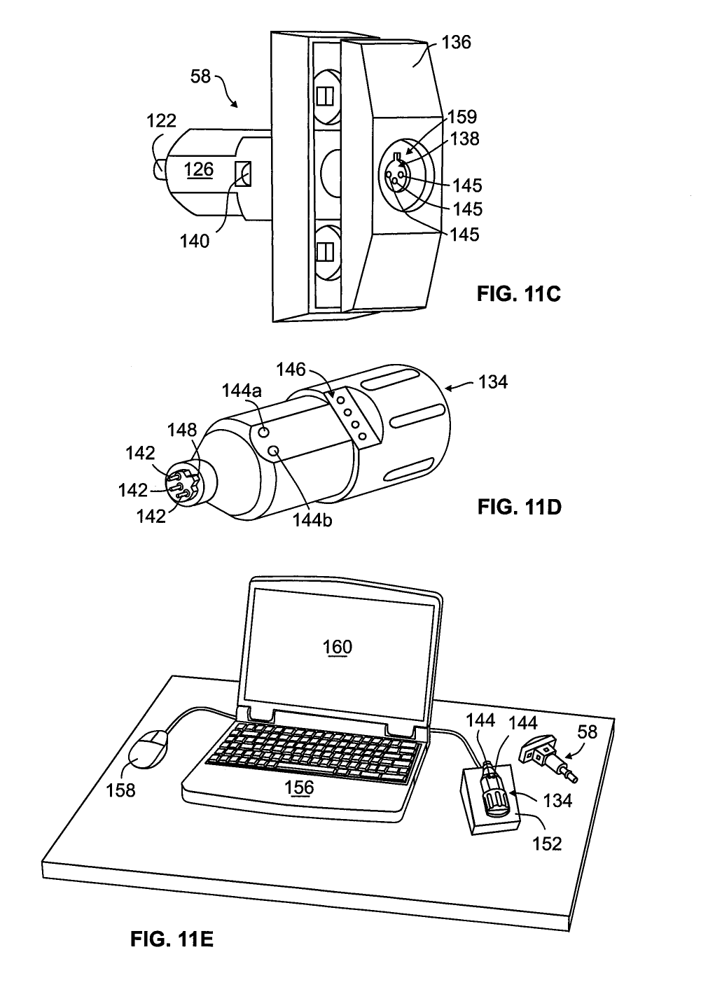

FIG. 8A is an isometric view of the lid locking assembly 54, 56, 57 showing an optional flexible weather cover 118 in the lowered, open position. Note angle flange 57 in the locked position extends over the edge of lid 38. At each end of the lock cover 56 is a flange 61 that extends to just contact the front wall 34 or the optional exoskeleton panel plate 80 to prevent access to the cam-type lid latches from each side of the lock cover plate 56. When locked, the only exposed portion of the lock assembly 54 is the lock key plate 58, where the key 134 is placed (see FIGS. 11A and 11B). To protect the lock aperture from weather, weather cover 118, made of flexible rubber or plastic polymer pivots into place when access to lock plate 58 is not needed. Weather cover 118 moves along pivot arrow E.

FIG. 8B is an isometric view from the interior of the lid lock assembly 54 in its housing 116 engaging the latch plate 108 in the locked and upright position. In this view, a rear access panel (not shown) of the lock has been removed, revealing cover plate mounting blocks 124, and exposing lock body 126. As flanged lock cover 56 is moved into the upright position (see FIG. 7B), latch plate 108 which is welded at 230 to mounting rod 110 (and also to lock cover 56, see FIG. 7B) has been moved through slot 114 into the locked position so that lock plunger 122 (also called a pin or shackle) is extended through latch pin hole 120, locking flange 57 over the top of the lid 30, see FIGS. 7A, 7B and 8A.

FIG. 9 is an isometric of the interior of the SMC showing the load volume 62 and including optional body interior reinforcing plates 104 bolted through the side walls (the rear wall is shown) to secure optional front and back end wall exoskeleton panels. (front wall panel 80 is shown). Also visible is an interior reinforcing bar 68 along the inside top edge of the side wall, and bolts 98 securing the optional bottom exoskeleton panel 84 to the bottom of the SMC 16. The inside opening of the gas port 64 is shown on the upper left, but it can be at any location on the front or rear wall, preferably near the bottom right of the figure shown to assist in good gas flow through the container volume. An auxiliary audio alarm is shown at 184 in the front wall.

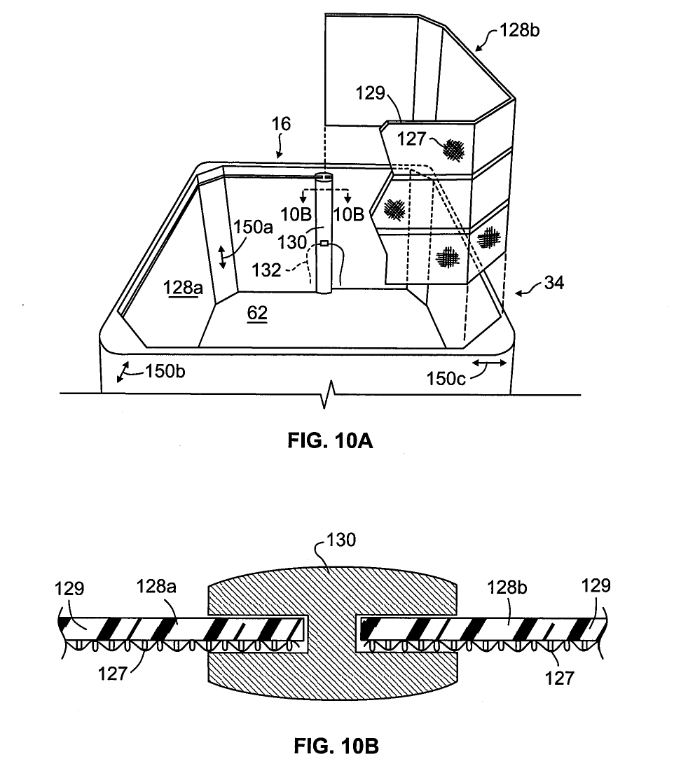

The electronics bay 170 for the smart SMC cargo container is shown in the front right inside corner of the SMC (the cover panel is not shown). From bottom to top is trickle charger 172, battery 174, and a combined RF transceiver/microprocessor unit 176, and GPS unit 178, the latter being located in a recess in the top lip of the SMC corner or side wall, which is covered by panel 180. This locates the GPS out of the way of shielding exoskeleton metal. Shown in dashed lines behind the trickle charger is an outlet for the charger plug into external power supply. The battery is trickle charged during warehousing, during transit or at its destination by plugging external 110 v power into the outlet. The battery powers the remainder of the electronics. Although not shown in this figure, the battery/trickle charger system can also power the audio alarm 184 (see FIG. 7B) and sensors 196 as needed. An optional, but preferred, red LED 182 projects through the side wall to be seen from the outside. Optionally, a second LED 182 may be located to be visible from the inside when the lid is opened, as seen in FIG. 9. The LED(s) are also wired to the micro-processor and light when the system is armed. In addition, the Molex connector on the bottom of the RF/microprocessor unit 176 includes a lead and connector 194 (see FIG. 9) to an optional side wall security screen array 128, best seen in FIG. 10A. Thus, when the screens are cut, the RF/GPS unit can signal out the event, time, and location.

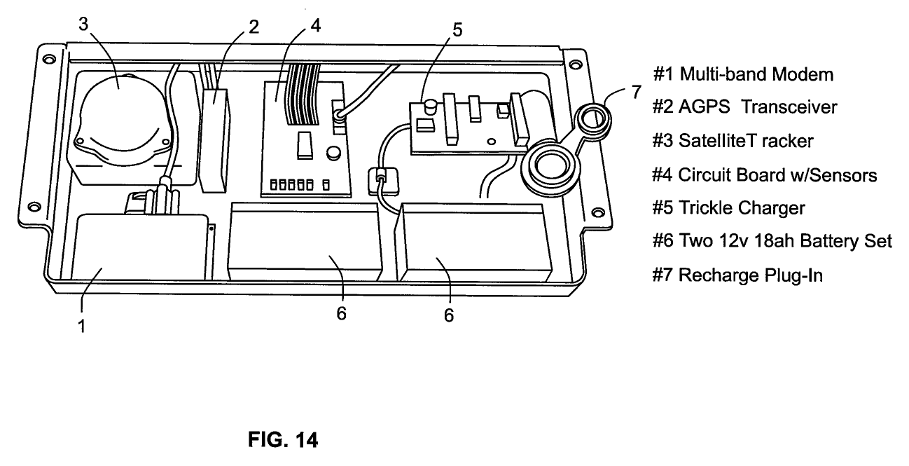

An optional electronics package is shown in FIG. 14 that fits against the inner surface of the front wall of the SMC. It should also be understood that a wide variety of sensors 196 can be placed in the electronics package, or on the interior or exterior of the SMC top, bottom and side walls, or distributed inside the SMC cargo volume 62 and hard wire-connected through a Molex connector on the RF/GPS unit 176. Optionally, and preferably, the sensors 196 communicate their data outputs via short range RF to the unit 176 to signal their state, status or an anomalous condition. These sensors 196 may be powered by the battery 174. Preferably, sensors 196 include their own battery power (typically small hearing aid, watch or camera type disc batteries, or kinetic power units) that provide enough power for years of operation. The sensors 196 can detect, among other conditions: intrusion; ionizing radiation and X-ray; sound; light color, contrast and intensity; ultrasound (US); infra-red (IR); electro-magnetic fields; current, voltage and resistance; humidity; pH; temperature, including absolute values, change and rate of change in temperature, including both external ambient and internal; motion, such as change of direction (inertial), acceleration and speed of travel; transient vibration, displacement, inclination and shock; pressure, weight, load and force, including absolute values, change and rate of change in values; and gases, fine particulates, fumes, chemicals and biologicals, by type and amount, such as gaseous CO, CO2, 03, N2, H2, or volatile hydrocarbons, e.g., smoke, propane or gasoline, explosives, Anthrax, Ricin, and Sarin, Chlorine, Bromine, Tabun, Soman, VX, Phosgene and Diphosgene, Chlorpicrin, Hydrogen Cyanide, Arsine, Agent Orange, or other immobilizing, irritating, incapacitating or lethal gases (including single components of binary, ternary or quarternary gas mixtures); and the like.

Optionally, the sensors 196 may be RFID/MSC tags on totes or products placed in the SMC, which are read by the SMC electronics package to create a load/unload inventory and audit trail. Since the SMC electronics can be polled to read the presence of RFID/MSC tags at any time, and to relay the data outward via the RF transmitter, this permits real time polling of the presence and location of individual RFID/MSC-tagged product packages.

In addition, the sensors 196 can include air tubes from the outside surface of the SMC container body leading into totally encapsulated (sealed) sensors located inside the box or in the microprocessor unit 176. The sensors can be preset to sample parameters every one to 2 seconds up to once every several hours, and transmit updated and normal data in periodicity ranging from every 1-5 minutes or so to once per day, or only as changes or events occur. The periodicity and range of transmission may be adjusted to accommodate particular goods or conditions. Where there is no change, or the changes are within a predetermined acceptable range, the sensor can go into a sleep mode until the next programmed reading and transmission. In addition, the sensors can be polled and respond back with a reading upon request from the relay or RF/GPS or GSM unit to which the sensors report.

As described, the sensors 196 can be distributed in or on the SMC, or can be mounted on the PC board of the microprocessor in the electronics package control unit 176. The sensors sense conditions a predetermined value above or below a baseline value, compare and conclude that the sensed signal is an anomaly, relay that to the microprocessor in the controller 176 which in turn further analyzes the information and packages it with other data from other sensors and the GPS system and radios it out. The RF transceiver is a transmitter and receiver that relays the information to a designated site, such as a home base or service company server, typically via a cellular telephone VPN or paging network (950 MHz, or other FCC designated frequency). Where the truck has a master GPS system (GSM), the RF transceiver in the box can radio to it, which packages the sensor data with its GPS then-location data of the vehicle, and relays that to the server.

The RF/GPS or GSM units can also be programmed to alert the driver. As a working example, consider a delivery truck in which the SMC containers or the truck cargo hold includes external ambient temperature sensors. In the case where the SMCs are loaded with heat labile or freeze sensitive organic or biological materials, such as vaccines, labile drugs, laboratory specimens, or the like, when an un-permitted temperature or rise in temperature is detected in the cargo hold, the containers can be polled via the transceiver to report back the temperatures inside the individual SMCs in the lockers. Where the temperature is high (or low) or the rise (or drop) exceeds a predetermined rate, the driver or other attendant can be paged so he/she can make provisions to correct the situation, such as alternate routes or shelter. Likewise, the driver can be paged if one or more containers detects an anomalous condition at any time.

Short range RF (wireless) sensors of the type useful in the smart container system, having frequencies in the range of from 308 to 916 MHz and a battery life of 3-5 years, are available from Radio Data Corp of Scottsdale, Ariz. and communicate via a sensing transponder (or the transponder has its own on-board sensors) as well as being able to receive transmissions from a Radio Data Corp Universal Sensing Transmitter (USST) and other external wired sensors or status indicators. It also has a micro-controller, a 916.5 MHz transceiver, a flash memory and a real time clock (for data storage) and either an RS232/485 interface or a USB interface. This can either connect directly to a GSM, GPS/GSM or GPRS unit or it can communicate (using the 916.5 MHz transceiver to a reader that can have an 802.11, 802.15, 802.16, GSM or other global communication link. The transceiver can also be used to send local alarm signals to a Radio Data Corp Key Fob Alarm that can be worn by the driver or attendant, thereby paging them. The transponder is a collector of multiple sensor transmitter signals and the reader is a concentrator of multiple transponder signals. Radio Data Corp also provides a Key Pad Poller which allows manually coded transmissions (or instructions) to be entered into the system via either the transponder or the reader (like a parking space or loading dock number) or it can be used as a load or door status indicator.

An example of an RF/GPS unit of a type useful with the controller 176 in the smart cargo containers is a PADTAG unit available from PAD, Inc. of Longvalley, N.J., in which case the RF transmission is sent to and received by a paging or reflex network (950 MHz), and routed to a base station server. Each shipper, customer or other authorized tracker can access data on individual ones of the SMCs, the totes, or groups of any or all of them via a customer or user name and password on an SSL server webpage. The tracker can poll where the SMC/tote is, and the location provided by the container's GPS/GSM/RSSI unit will be displayed on a map. In addition, in the case of an anomalous condition being sensed, such as: unauthorized unlocking; attempt at tampering, entry or opening of the container; unlocking at an improper location; sensing temperature, humidity, chemical conditions, and the like, the system will wake up and emit an alarm, including audio, visual, sending of e-mails, faxes and phone calls, to a selected number and type of individual for response. The Radio Data Corp wireless sensors can be mounted on a Radio Data LITMIS daughter board mounted on the PADTAG controller board. An example of a commercially available GPS unit is an Earthmate GPS LT-20 unit, available from Delorme (delorme.com), or similar units from Garmin, Magellan, Lowrance and Philips.

It is preferred to include an audio alarm system in the smart container. As best seen in FIGS. 7B and 9, a battery-powered 90-120 DB audio alarm unit 184 is disposed in the front wall 34 (and/or any other wall of the SMC) just behind speaker grille 186. This alarm is activated by simple magnetic or button type contact switch elements 190, in the lid and top of the box wall or interposed between the inside face of the lock cover plate 56 and the lock housing 116, respectively, as best seen in FIGS. 7B and 9. A switch 192, see FIG. 7B, arms or turns the alarm off. If the lid is opened or the lock cover plate is removed or lowered, the alarm sounds. A delay of a few seconds can be provided in a conventional manner. In use, after unlocking the cover plate 56, the switch 192 is accessible, and is moved to the off position. Then the top 38 can be unlatched via cam latches 42 and opened. The circuitry is straight-forward for the audio alarm, its battery, the NC magnetic switch, and the toggle switch, based on the principle that when the circuit is broken the alarm will sound.

The cam latches and/or toggle switch 192 can be replaced with a biometric switch, comprising a biometric scanner (e.g., finger print or retinal scanner), comparison logic and solenoid latch to permit shut off of alarm or container or tote lid opening, if desired.

It should be understood that the red LED 182, or a duplicate of it, can be part of the audio alarm circuit. Where two red LED's are used, when both are illuminated, it means both the RF/GPS system and the audio alarm system is armed. Instead of two red LED's different colors may be used, e.g., red for the RF/GPS system and blue, white or yellow for the audio alarm. In other embodiments, the SMC container may include a number of externally visible status or condition LEDs, the function of which is signal status including at least one of an armed condition, an open condition, a battery low condition, an attention-required condition, a wrong location warning, and a breach or damage condition.

FIG. 10A is an isometric, partly exploded view of the interior of the SMC container 16 showing insertion and placement of optional, but presently preferred, side and end wall security screens 128a and 128b. A suitable security screen of fiberglass mesh interwoven with spaced, 30-gauge Tefzel-coated wire strands is available from National Security Screen, of Woodbridge, Va. The security screen 127 is secured to the outside of thin, but tough, rigid plastic paneling 129, such as styrene or ABS. The screen halves are suitably sized and shaped to conform to the inside dimensions of load volume of box 62. Two halves, 128a and b are placed into the box and connected at one end with wire connector 132, so that any breach to the surface of the screen triggers the electronic security system which alarms, tracks and audits each specific container. FIG. 10A also shows schematically, three orthogonally oriented kinetic power devices, 150a, 150b and 150c disposed in the side and or end walls of the container to provide power, or recharge power to the electronics or sensors.

FIG. 10B is a section view along lines 10B-10B of FIG. 10A of the H-connector 130 that retains the interior security screen panels 128a and 128b. As an alternative to the hard-wired screen intrusion or wall-breach sensor, any suitable RF sensor can be used, such as one or more light or sound detecting sensor(s) capable of detecting cracks, drilling through the walls, cutting with saws, or the like. The RF sensor communicates to the controller which in turn reports the event.

FIG. 11A is an isometric of the knob or handle-shaped electronic key 134 inserted in the lock aperture 59 (keyway) of lock 58. FIG. 11B is an isometric of the electronic key inserted in the T-handle type cylinder lock assembly, and rotated clockwise into the “open” position (see Arrow F in FIG. 11A) to release the lock cylinder 126 and its plunger 122 (see FIG. 8B). FIG. 11C is an isometric of the lock popped open upon turning the key as in FIG. 11B. FIG. 11D is an isometric of the programmable electronic key 134 showing the electrical contacts 142 through which signals pass to lock 58 when the properly programmed key has been placed in the key aperture 59 to engage the contacts 143 in plate 138.

Viewing this series of figures, upon insertion of key 134 into aperture 59, the key contacts 142 engage the corresponding contacts 143 of the lock. When the key code and lock code match, a green LED light 143a is illuminated and the key can be turned. If a red LED 143b lights up, the codes do not match and the access is not authorized, nor will the key turn in the lock.

Assuming an authorized key code is matched, the key 134 is turned along the path of Arrow F (the lock can be oriented so that the key has to turn either clockwise or counterclockwise, when viewed from the right side, to open). When turned, the key 134 releases catch(es) 126, and lock bolt or plunger release the T-handle 136 (best seen in FIG. 11C), is spring-biased to move outward along Arrow G (in FIG. 11B). That allows locking pin (plunger or bolt) 122 to be pulled out of latch plate hole 120 of latch plate 108. The lock is now opened and the lock cover 56 can be rotated down to provide access to the cam latches 42 on the front wall 34 of the SMC 16.

Note that only when the lock and key code match (green LED signaling match) can the tang 148 of the key be rotated to release the catches 126. Releasing latch plate 108 permits flanged lock cover 56 to open, which in turn permits lid latches 42 to be released from tangs 60 for access into SMC interior 62. By way of example, a suitable electronic lock is the “NexGen” electronic high security lock system, available from Medeco Inc. of Salem, Va., USA, a division of Hillenbrandt Industries, Inc. The NexGen electronic lock provides access control, audit capability, route management and the physical security of a high quality mechanical lock. No hardwiring is required of the lock because it derives all of its power from the programmable key, which is battery powered to last for up to 6,000 or more audit events. The software system permits the user to program into the key, authorization who open the lock and when to do so. Both the lock and the key may contain event memory, minimally the key and preferably both. Upon download of data from the key or/and the lock, the software program provides detailed reports for complete security management, including all openings and attempted openings. Because the keys are electronically reprogrammable, locks and keys can be immediately rekeyed to replace lost or stolen keys. A single key can access up to 11,000 differently programmed locks, and each lock can store up to 2,000 audit events. While the electronic keys are currently available in four different styles, each is designed to be able to open T-handle cylinder, cam or padlock style locks. In the instant SMC cargo container, the T-handle type cylinder lock is preferably employed with the cylindrical, round end, handle-type key.

As seen in FIG. 11D the programmable electronic key 134 includes spring-biased protruding pin-type electrical contacts 142 which signal lock 58 when the properly programmed key has been inserted in the key contact plate 138 (also known as a “plug face”) to align with the respective shallow recess contacts 145 in the lock. As described, when electronic “recognition” between lock and key has occurred, the green LED lights-up, and when there is unauthorized attempt, the red LED lights-up. The key includes a flat with a plurality of contacts 146, four being shown, for proper orientation of the key in the programming cradle. This is seen in FIG. 11E, which illustrates programming (pre- and re-programming) key 134 via the contacts 146 on the opposite side of the key, as seen in FIGS. 11B and 11D.

FIG. 11E is an isometric of the hardware for configuring use authorizations and audit trail downloads of the electronic key of the smart cargo container. Key 134 is resting in cradle 152, its underside flat aligning it to the cradle's pins 154. Programming contacts 146, seen in FIGS. 11B and 11D, are not visible in this view, as on the underside of the key 134, aligned with programming contacts located in cradle 152. Programming is performed using a laptop or desktop computer 156, shown here with standard mouse 158 and monitor display 160. LED lights 144 (seen also in FIG. 11B), one red and one green, light when the programming is in process (red) and complete (green). Alternatively, the programming can be done by use of a hand held PDA or tablet computer. In addition, the red/green LEDs 144 can be amber/green or any other color combination, and can indicate the key is downloading the accumulated data from its memory and download complete, or the like suitable code.

The electronic locks have a hardened steel shell (the body 126, bolt or plunger 122, release T-handle or head 136 and plug face 138 as shown in FIG. 11C), and the keys electronically record in included memory (for example, flash memory) on the order of thousands of separate auditable events, including at least one of: opening attempts; failure to open; positive open events; time of event; and the duration that the lock is in the open state. In addition, the keys can be programmed at home base (see FIG. 11E), or in the field by laptop, PDA, cell phone (including Blackberry or Sidekick) and the like devices, and the programming configuration code can be provided from a remote center to the programming cradle driving device (laptop, FDA, cell phone, etc.). The keys can be programmed to open locks only within specified time parameters. Each key is uniquely identified, both electronically and by bar code strip on the side or face of the key, and can be issued on a restricted basis to only authorized personnel, and be accounted for. When the key is inserted in the lock, the lock memory can download to the key, so that upon putting the key in the programming cradle the lock history data can be downloaded to the computer system for analysis and reports.

The electronic keys useful in the SMC need not have physical contacts as in the above described, non-limiting example, but may be activated via an RF proximity-type system to provide the key/lock recognition/authorization functionality permitting the key to be rotated in, or otherwise open, the lock. In addition, the lock may contain within its body 126 or within the housing 116 a flash memory drive to record a wide variety of events related to the lock, such as the ones enumerated for the key, or the condition status of the box.

In another important alternative embodiment, a GPS unit is incorporated in, or electrically connected to the lock or the key to provide a second level of access control, in that the lock is programmed so that if it is attempted to be opened at other than a pre-determined, pre-programmed destination, the lock will not open. Thus, upon the key being inserted in the lock, the then GPS coordinates are checked and compared to the programmed location in the memory of the key or lock, and if GPS coordinates compare, the green LED lights or flashes and the lock can be opened. As in the above example, if the coordinates do not compare within a pre-selected margin of error, e.g., within the accuracy of the GPS unit (within a few feet), the lock will not open. In either event, the history record will be stored for future download, or real time reporting by RF, e.g., Pager, Cell Phone, Bluetooth or other wireless network. Thus, the unauthorized event can be reported in real time to on site, near-by local, regional or distant location, by direct RF, or via RF to a local WAN or LAN wireless (e.g., 802.11-type) router that communicates via the Internet to a server at the shipper's, customer's, or security service (including governmental, military or law enforcement) headquarters or service center for appropriate action.

FIG. 12A is a schematic block diagram of the architecture of the controller and data communications system as employed in the smart cargo containers, and FIG. 12B is a schematic of the system and operational architecture of the remote electronic tracking and security condition reporting by the smart containers. The smart container data communication and management system includes sensors, locks, alarms, container armed status lights, data encoders, transmitters and/or transceivers, computer programs, data bases, and related equipment to enable activation, coding, decoding and use of the data communications system, including real time and past history display of status and location, and management and operation report generation. The smart cargo container monitoring and management electronic data communications system includes container-mounted components 200, separate remote signal relays (VPN cell phone towers 198, satellite 208), monitoring station components 210, and auxiliary equipment including locators (GPS locators) 178 and locking systems 54. The home base monitoring station 210 includes a computer system having a CPU 162 in which is loaded data engine, display programs and web server or web browser programs to enable activation, operation and use by customers of the data system.

As seen in FIG. 12A, the SMC 16 includes a communication module 200 which comprises a programmable Peripheral Interface Controller (PIC) 214 mounted on microprocessor controller board 176, a battery 174, optional kinetic power system 150, a transmitter or transceiver (transmitter/receiver) 212, trickle charger 172 connected to the external power via outlet 154, and a wide range of inputs (lock 54, security screen 128, GPS 178, sensors 196) as well as I/O ports 216 for configuring the programmable PIC by computer, and outputs including selected frequency command signals for short or limited range RF broadcast 218a (e.g., to a master GSM, transponder, transceiver or repeater, unit in the truck, moving van, warehouse or via a reader as the truck/van passes a way station), or longer/full range RF broadcast 218b (e.g., to pager or cell network towers or satellites) audio alarm 184, status LEDs 182, and others, 216. The container location and status data can be sent as text, and can include a time stamp. The PIC can conserve battery use by turning the radio “ON” just before a transmission will be sent, and can be configured to transmit a ⅓ second position burst after container data input, or to send container status/condition data on command from home base or at cyclic intervals. The PIC operating parameters are stored in its internal EEPROM that is configured from computer system 162 at home base 210, and will persist even when power is removed.

The remote monitoring aspects of the invention provides a method for customers, movers, shippers, manufacturers, clinic/hospital/medical provider personnel, security/audit personnel, and others concerned and authorized, to monitor from a single “home” base, many containers simultaneously, the number ranging easily in the tens of thousands. Within the present system, the tracking personnel can be notified and check when anomalous events occur and can have a complete handling report for each container from empty before loading to empty upon unloading at its destination, and with confidence in the security of the container along the route, including in the transport vehicle (truck, ship, rail, aircraft), in its origination facility, warehouses or transfer depots along the way and to destination unload or storage.

The present security system provides a unique identifier for each container and/or tote in the field that is radioed to “home base” when the container is first put in use. Each container is pre-configured at home base (e.g., home warehouse, customer or shipper facility, manufacturing facility or the like), or in the field via the PIC program with a unique identification number or other data (name of customer, shipper, type of goods permitted to be shipped, etc.), and its cycle of time for status reporting is pre-selected at that time. After loading and closed, it is initialized or enabled, and thereafter the container reports its status, the time, or/and location back to home base on the predetermined timed cycle, e.g., every half-hour, more frequently at night, less during the day, etc.), or to pollers (very short range, long-life battery powered microprocessor-controlled RF transmitters that are placed at various sites around the warehouse, storage facility or customer location), or readers (long range, 100-1500′ depending on antenna) transceivers with the ability to receive an interpret the data from the container transponders and then forwarding this information by wired or wireless communication to a computer or computer network for real time location and status data retrieval from the containers). The program at home base displays a map from the map program with each container or group of containers located thereon with a unique icon, and the status can be indicated in text or change of icon, e.g., by animating the icon, changing color, flashing, change of text, combinations, and the like. In addition, an audio alert signal can be emitted on the computer speakers when the sensor or lock detects an anomalous event or unauthorized, untimely, or wrong destination attempts to open the container occur.

The computer-enabled SMC/Courier container system permits complete segregation of mandated/legally controlled products, such as ethical drugs, and total management of the container security during use, transport, storage, loading and delivery, as a business, including communication via the Internet of container status and event reports, orders, billing, e-mail communications, and the like. The system provides a rugged, competent, legally verifiable chain of custody for a wide range of applications, including moving of ethical drugs and controlled products. In addition, the status reports of each container/tote can be viewed and printed out for analysis, or can be computer-analyzed to show status and anomalous events, including access opening and locking, related by time of day, customer, shipper, by location, and the like. The accumulation of container handling data for a particular site, particular customer, particular shipping line, particular type of goods, and the like, over time can also be analyzed to reveal changes in commerce, types of events, patterns of attempted theft or damage, reduction in theft, and the like.

The communication system includes provision for a wide range of inputs for any given container or type of goods being shipped or stored therein. That is, the PIC can accept a variety of sensor inputs, both interior of the container and external to it, by placement of appropriate sensors that are well known in the art and commercially available. For example, IR and US sensors, microphones, bolometers, vibration sensors, accelerometers thermometers, humidity, pressure, and surveillance optics (some as small as coin sized) are readily available. Following the principles taught herein, one skilled in the art will easily be able to mount any selected sensor(s) and hook to the PIC for transmission of the sensed data back to home base for display or storage in the computer database. In the embodiment(s) in which a transceiver 212 is mounted in the container, the home base can selectively poll individual sensors for readings, or the PIC can be programmed to provide selected readings on a timed cycle. For example, upon receipt of a signal from the security screen 128 that it has been breached, or from the magnetic sensors 190 that there has been an attempt to jimmy the top of the container, the PIC can be programmed or a signal can be sent from home base to turn on a microphone and/or camera to ascertain more data about the event, or to collect law enforcement or prosecution evidence.

Typically, the RF VPN transmitter 212, or the truck-mounted master GSM unit, transponder, transceiver, or reader 206 in the cab or in the trailer of the truck or van 10 (see FIG. 12B), sends a data burst lasting less than a second and is only powered when sending; that is, the transceiver 212 is OFF until the programmed PIC 214 sends a wake-up signal (power enable signal) to the transmitter for the transmit burst. The PIC is preferably configured to send an event-has-occurred signal immediately upon the event, rather than wait for the next cycle. The PICs of different containers in a given cluster, e.g., warehouse or truckload, are preferably configured with different cycle send-times so that no two containers send simultaneously to home base.

By way of example only, since the bursts typically last less than a second the theoretical number on a single frequency is 3600 repeated hourly, but typical is every 30 minutes for 1800 container capacity. It is also possible to set the container communication module 200 to repeat the burst in time-spaced intervals, once each 5 seconds for 3-6 tries, therefore 1 minute spacing between different container reports is more typical. As an alternative to the pager network frequency of 950 MHz or cell phone frequencies (any one of the quad mode frequencies available world-wide), a useful RF frequency is one of the no-license required frequencies of 154.600 MHz±5 kHz (Green Dot), and 154.570 MHz±5 kHz (Blue Dot). However, dedicated licensed frequencies can be obtained for use through an FCC-Licensed Frequency Coordinator. Thus, different containers of different customers or shippers can communicate by different frequencies, so the real-time monitoring of thousands of containers simultaneously is entirely feasible under the system.

As shown in FIG. 12B, the RF VPN transceiver/transmitter-containing in-container module 200, or the in-truck transmitter/repeater/reader 206 can transmit to cell tower 198 or satellite 208. In addition, can receive as well from either cell tower 198 or satellite 208, including the GPS coordinate system via satellite 208. The transceiver 212 of home base 210 receives the signals, processes as described above and displays the text data or map data on monitor 160, or prints a report on the printer 168. The system is interactive via peripheral input: devices, such as mouse 158 and keyboard 164. In addition, the CPU or server 162 (in the case where home base is a tracking service center server) can communicate via hard wire (DSL, fiber, cable, etc.) 220a or wirelessly 220b to the Internet, to access by browser or serve pages that are accessible by the service center customers, e.g., shippers, customers and security service and tracking personnel. That is, the home base of a customer does not need to have a transceiver for direct receipt of the reports. Rather, the customer can access a service center site, enter a customer number and password, and then be served and have access to pages on which that customer's container status and history reports and present location maps are displayed. In addition, the service center can automatically enable event alerts by e-mail, fax, or telephone to the customer. The service center can also alert the driver or vehicle/warehouse attendant(s) to check as events occur and warrant. The receiver in the container can be interrogated (polled) from home base requesting reports of available data.

As shown in FIG. 12B the truck 10 may also be the supplier's or customer's factory or office of origination or destination, a warehouse or freight forwarding transit location, a hospital or clinic or the like. That is, the polling and tracking are location independent.

The computer system 162 is powered by AC or in the case of a laptop or PDA, by a suitable battery. The computer system at home base (or a portable, such as a laptop or PDA) is loaded with suitable operating system, applications programs, Internet browser(s), image transfer and e-mail programs. By way of example, a packet engine program and an APRS program with map data are employed to decode the RF transmission from the containers in the field, and to display the location, identification and status (at identified time/date stamps) of each container, as well as set the parameters for reporting the container status on a timed cycle. A suitable software-only packet engine is the AGWPE program available as shareware (for a contribution license fee) from www.raag.org/sv2agw/pepro.htm, which permits receipt of the data from the receiver 212 directly into the sound card of the computer. Alternatively, a packet modem can be used to convert the receiver 212 signal to digital data for input to the serial port of the computer system 162. The AGW Sound Card portion of the AGWPE program permits tuning the audio signal, permitting setting of the volume and squelch of the input signal from receiver 212, in cases where audio alerts of anomalous events is desired.

A suitable display driver for the map display feature of the system is an APRS application program, available from www.winaprs.org. These programs are available in Windows, Mac and Linux operating systems, as WinAPRS, MacAPRS and XAPRS, respectively. These two programs function as the interface that takes the data from the sound card or the packet modem into the packet engine and the APRS places the trap location/status data on the map program.

Any suitable map data that interfaces with (becomes embedded in) the selected APRS program is used to provide map images. Suitable sources of map data includes: Tiger Maps, which is Census Bureau map data available from www.census.gov/geo/tiger/. Other sources are US Geological Survey, NASA, Delorme maps, Microsoft MapPoint and Microsoft Streets and Trips.

In addition, the computer system can be configured to communicate via the Internet 202 selected data for operation of the container security system as a computer enabled Internet-based business. This includes reports, communications and billings to remote clients or associates, franchisees, regulatory agencies, law enforcement, shippers, customers, and the like. It permits a central home office to communicate with regional offices or remote warehouses or shipping depots. Local, regional or national “views” of shipping and container security activity, such as the real time shipping loading, unloading, access and sensor events, can be communicated automatically to the remote home offices, permitting a nation-wide management operation.

Thus, the computer-enabled Internet system of this invention includes a base station including a transceiver for receiving RF signals from the SMC container RF transceiver, and a computer system including: a web server for securely serving pages to clients and a CPU and memory that includes operating and applications programs that receive, analyze, serve and save, in at least one database structure, time-related and real time security status and location data from a plurality of said containers, including pages having annotated map information of the container identification, map location and movement and event alerts; and at least one client SMC container-monitoring computer system that includes a CPU, memory, at least one display, and input/output peripherals, said CPU and memory including operating and applications programs that cause the client computer system to access the Internet and receive web pages served by the service bureau base station server upon entry of client authorization data, these web pages including at least the real time and time-related security status and location data about containers for which the client has authorization to monitor, in graphical or text format.

The computer systems of either or both the tracking service server or the customer can include a database of the history of handling of each container tracked and serves that history to the client upon request. This history includes at least one of: a unique identifier for each container; opening attempts, times and durations; personnel authorized to open a container; electronic lock configuring information; handling locations and times comprising shipping and storage events; anomalous events sensed by container sensors; ownership of each container; identification of shipper and customer for each shipping and storage period; nature or type and amount of goods shipped or stored, and the times and periods involved, and the like. That is, any history deemed relevant by the customer can be harvested, stored in a database, retrieved and displayed.

FIGS. 13A-13D are a series of photos showing a second SMC container configuration, here a 2-wheel Courier container having a telescoping handle assembly secured to the bottom end (as seen FIG. 13D). The side facing in all photos is denominated the front. The exoskeleton is visible on the top. The wheels are seen at the lower end, left side in the photos and in FIG. 13D. A handle is also seen at the left end, and a similar handle is presented on the right end as seen in FIG. 13D. The L-shaped lock plate is seen in all figures, closed in FIGS. 13A, 13B and 13D and open in FIG. 13D. The lock plate is hinged to the exoskeleton along the upper flange marginal edge, and it folds up to reveal the electronic lock, see FIG. 13C in the middle of the front wall of the Courier SMC. In FIG. 13B the electronic key of FIGS. 11A, 11B and 11D is used to engage the recessed lock contacts. In FIG. 13C the lock has been opened and the lock plate lifted up to reveal the three lid latches, formerly covered by the lock plate. In this figure, the lid latches have been opened. The container lid can now be opened.

FIG. 14 is a photo of the internal electronics package that is secured to the inner face of the front wall of the Courier SMC (and optionally to the larger 4-caster version of FIG. 3 that fits in the under-deck lockers of FIGS. 1, 2 and 4-6. Typically there is no need for a face-plate covering between the mounting flanges on the left and right edges (mounting screw holes are seen on the left flange) since that face is against the inner wall of the SMC. Optionally a laminated expanded metal screen plate can be used to cover the e-package housing. The figure identifies the modem, transceiver, satellite tracker, mother board with sensors, charger, battery set and recharge connector plug.

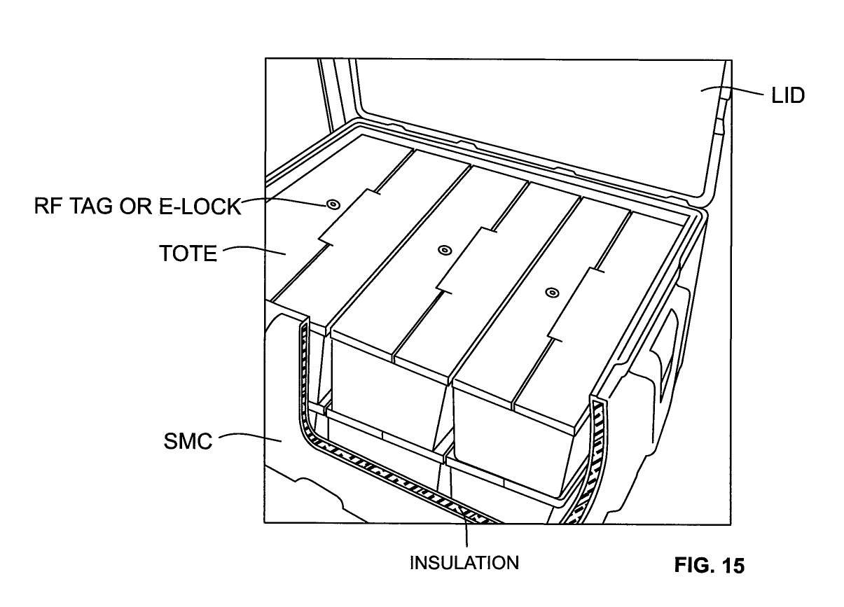

FIG. 15 shows the SMC of FIG. 3 with the lid open, and the front and part of the right side wall broken away to illustrate packing with, in this example, 6 totes. Wall insulation is also shown. Active RF chips are seen on the left side lid of each tote, and are removed from the SMC, the reader in the electronics package of FIG. 15 reads and records the removal for the load/unload inventory audit trail. In the alternative, the tote lids can be secured with electronic locks of the type disclosed. Thus, each tote would be required to be opened with an authorized electronic key, and the audit trail would extend to the tote level of packing and shipping.

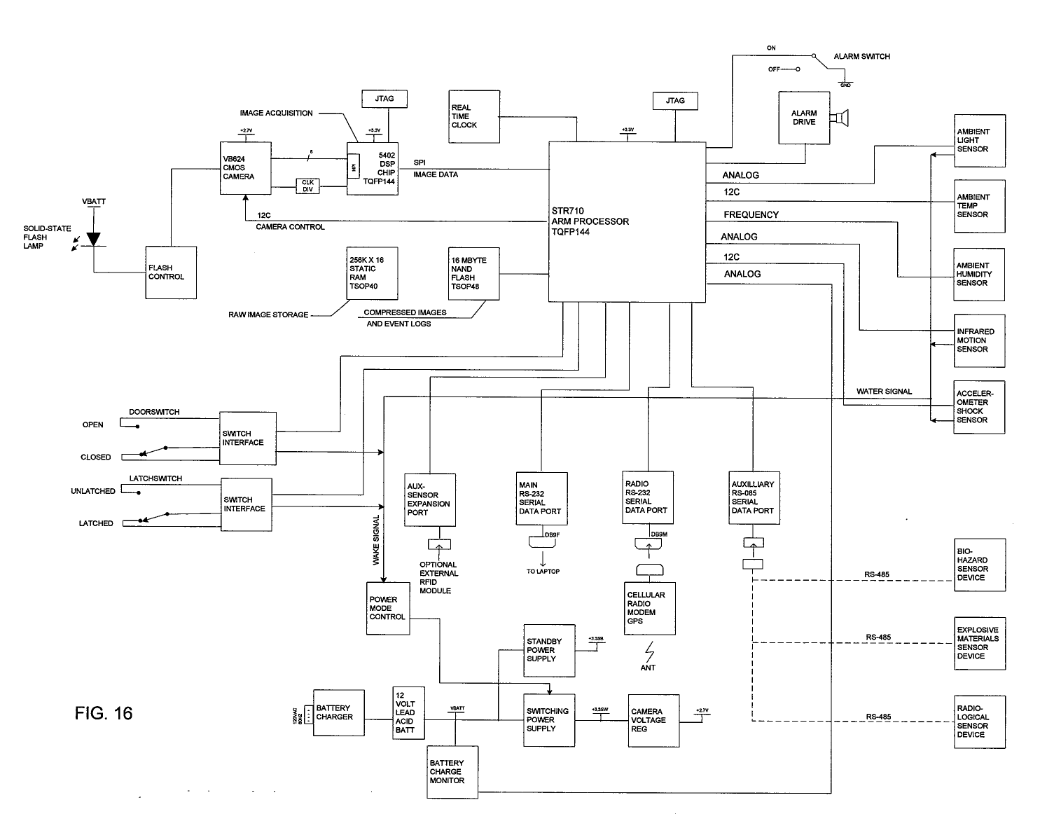

FIG. 16 is a block diagram of an exemplary topology of the components of an electronics package for the SMC containers of the invention. Each component is labeled so that the diagram is self-explanatory and a complete depiction that is clearly enabling to those skilled in this art. Note the toggle switch 192 is at the upper right, along with the 120 Db alarm. Just below is a vertical array of the standard sensors connected to the ARM processor. Additional biohazard, explosive and radiological sensors are listed next below, connected to the ARM via the auxiliary RS485 serial data port. The cellular radio modem is connected via the RS232 serial port, and an externally accessible RS232 port permits connection of a laptop, PDA or other devise in the field for configuration, downloading of data, uploading of upgrades, and the like. The RFID module described above for reading the passive HF tags or the active 5 GHz tags is also provided and shown. The power components are shown below, left, including the external recharge plug, batter, battery charge monitor, power mode control, standby power supply, and power switching. In addition, the power to the camera is shown, with the camera auxiliary (daughter) board being shown on the upper left, which includes an SS flash lamp, flash controller, CMOS camera, image acquisition firmware and DSP chip, raw image storage in static RAM, compressed image storage in NAND flash RAM. The lid open/close and latch open/close switches are shown. on the left, center. The real time clock for logging events by time is shown top, center, and just below is the motherboard with ARM processor.

It is clear that the controlled product segregation and secure transport system of this application has wide applicability to the medical field, namely to transport of ethical and prescription drugs from pharmaceutical houses to hospitals and clinics, and the like. The system clearly provides the ultimate in security, segregation of products from common goods, and tracking along with a verifiable audit trail. It also can provide a detailed load/unload inventory via product specific package RFID/MSC tags. Thus, the present system has the clear potential of becoming adopted as the new standard for apparatus and methods of secure, trackable, auditable transportation of goods requiring segregation and controlled distribution.

The present system includes the use of MSC spots or low frequency (13.6 MHz) or 2-5 GHz frequency RF tags that are applied, encoded and read at normal production speeds during packaging and distribution of pharmaceuticals to assist in verifying the authenticity of medications along each step of the distribution process. Thus, the present system provides an additional layer of security to lessen the chance of counterfeit pharmaceuticals entering the supply chain, not only in tracking at the unit, case and shipping container (SMC) level, but also by segregation of the products during distribution, end to end from manufacturer to the end-use in a clinic, doctor's office or hospital. Such RFID/MSC encoded tracking and ID data will improve efficiencies in the supply chain. Barcode may be used as complementary and redundant product ID and tracking data sources.

It should be understood that various modifications within the scope of this invention can be made by one of ordinary skill in the art without departing from the spirit thereof and without undue experimentation. For example, the lockers can have a wide range of designs to provide the functionalities disclosed herein. This invention is therefore to be defined by the scope of the appended claims as broadly as the prior art will permit, and in view of the specification if need be, including a full range of current and future equivalents thereof.

PARTS LIST

| | |
|---|---|
| 10. | Underslung Lockers |
| 12. | Trailer Deck |
| 14. | Trailer |
| 16 | Smart Mobile Container (SMC) |
| 18. | Casters |
| 19 | Caster track & optional wear plate |
| 20 | Front Wall of Locker = Door/Ramp |
| 22. | Hinge(s) |
| 24 | Hasp |
| 26 | Eye for padlock shackle |
| 28 | Exterior face of locker |
| 29. | |
| 30. | Position for Barcode on Locker |
| 32. | Barcode location on SMC |
| 34. | Front side wall of SMC |
| 36 | SMC (container) body |
| 38 | SMC Lid |
| 40. | Side wall handles (optional) |
| 42. | Latches |
| 44. | Lid Exoskeleton |
| 46. | Truck deck I-beams |
| 48 | Securing bracket |
| 49 | Bolt |
| 50. | flange |
| 52 | Bolsters; a) side, b) top, c) door/back |
| 53. | |
| 54. | Electronic Lock Assembly |
| 56. | Flanged Lock Cover |
| 57. | Flange |
| 58. | Electronic Lock Key Plate |
| 59. | Lock Aperture |
| 60. | Lid Latch Tangs |
| 61 | Optional Lock Cover Flanges |
| 62. | Load Volume of SMC (Interior) |
| 64 | Gas Port (female QD) |
| 66. | Optional Lid Perimeter Steel Band |
| 68. | Interior Reinforcing Plate |
| 70. | Hanger Brackets |
| 72 | Inverted J-Hook |
| 73. | Hose |
| 74. | Male Hose Connector |
| 75. | Arm |
| 76. | Pin |
| 77. | Tang |
| 78. | |
| 80 | Optional Front Exoskeleton Panel |
| 82 | Optional Rear Exoskeleton Panel |
| 84 | Optional Bottom Exoskeleton Panel |
| 86 | |
| 88 | |
| 89 | |
| 90 | |
| 91 | |
| 92. | Lock Rear Access Panel |
| 94 | |
| 96 | |
| 98. | Securing Bolts |
| 100. | Side or Bottom Box Walls |
| 102 | Rivets or Screws |
| 104 | Interior Reinforcing Plates |
| 106 | Interior Electronics Module |
| 108. | Latch Plate |
| 110. | Lock Cover Mounting Rod |
| 112. | Rod Brackets |
| 114. | Latch Plate Slot in Lock Housing |
| 116. | Lock Housing |
| 118. | Weather Cover |
| 120. | Hole in Latch Plate |
| 122. | Locking Pin/Plunger/Shackle |
| 124. | Cover Plate Mounting Blocks |
| 126. | Lock Body |
| 127. | Conductive Screen Mesh |
| 128 a.b. | Security Screen Assembly |
| 129 | Plastic Paneling |
| 130. | H-Channel |
| 132. | Connecting Wire |
| 134. | Electronic Key |
| 136. | Lock Plunger Release Head |
| 138. | Electronic Key Recessed Contact Plate |
| 140. | Catch |
| 142. | Key Contact Pins |
| 143 | a.b. LED Lights (green/red) |
| 144 | a.b. LED Lights (green/red) |
| 145. | Lock Contacts |
| 146. | Programming Contacts |
| 148. | Orientation Key |
| 150. | Kinetic Power devices |
| 152. | Programming Cradle |
| 154.. | External Power connector (male) |
| 156. | Laptop or Desktop Computer |
| 158. | Mouse |
| 160. | Screen Display |
| 162. | CPU or Server |
| 164. | Keyboard |
| 166. | Back-up Power Supply/Battery |
| 168. | Printer |
| 170. | Electronics Bay |
| 172. | Trickle Charger |
| 174. | Battery |
| 176. | RF Transceiver/Microprocessor/Controller Unit |
| 178. | GPS Unit |
| 180. | Cover Panel |
| 182. | Red “LED” |
| 184. | Audio Alarm |
| 186. | Speaker Grill |
| 188, 190. | Magnetic or Button Contact Elements |
| 192. | On/Off Alarm Switch |
| 194. | Lead and Connector to opt. Screen |
| 196. | Sensors |
| 198. | Pager/Cell Network Towers |
| 200. | Electronics Module in Box |
| 202. | Internet |
| 204. | Sensor(s) |
| 206. | In-vehicle or In-Box Transmitter, Transceiver or Transponder/ |
| | Master GSM |
| 208. | Satellite |
| 210. | Base Station |
| 212. | Transceiver |
| 214. | PIC |
| 216. | UO Ports |
| 218a. | Signal to Broadcast on Short/Limited Range Frequency |
| 218b. | Signal to Broadcast “Full Range” |
| 220a. | Hardwire |
| 220b. | Wireless |
| 230. | Weld |
| 240. | |
| 242. | |
| 244. | |
| 246. | |
| 248. | |
| 250. | |
| Arrow A | Travel of Arm 75 |
| Arrow B | |
| Arrow C | |
| Arrow D | Lock Cover Path |
| Arrow E | Weather Cover Pivot Line |
| Arrow F | Electronic Key Rotation |
| Arrow G | Opening Motion of Lock |

What is claimed is:

1. A container for shipping cargo, the container capable of being shipped within an under-deck locker secured to an under-side of a truck cargo compartment and having a lockable fold-down door for allowing the container to be inserted within and removed from the locker, the container comprising:
side and bottom walls forming a unitary container body and an internal space for receiving the cargo;
an openable lid hinged to the container body for engaging tops of the side walls;
means for locking the lid to the container body for preventing the lid from opening; and,
an electronics module disposed within the container, the module having a controller, a battery supply unit connected to and supplying power to the controller, an RF transceiver unit in communication with the controller for transmitting and receiving communication signals to and from a remote communications device, and an RFID reader in communication with the controller for receiving RFID information from an RFID tag associated with cargo which has been received within the container.

2. (canceled)

3. (canceled)

4. (canceled)

5. (canceled)

6. (canceled)

7. (canceled)

8. (canceled)

9. (canceled)

10. (canceled)

11. The container of claim 1 further comprising:
a plurality of condition sensors in communication with the controller and disposed within the container for communicating condition signals to the controller relating to internal conditions of the container.

12. The container of claim 11 wherein at least one of the condition sensors is a temperature sensor connected to the controller for communicating a signal to the controller representative of the temperature within the container, the container further comprising:
an alarm module within the controller configured to determine if the temperature within the container is outside of predetermined thresholds, wherein the controller is further configured to communicate an alarm signal to a remote receiver for communicating that the temperature within the container is out of range to a remote system.

13. The container of claim 12 wherein the remote system is within the cab of a truck that is transporting the cargo within the container for communicating that the temperature within the container is out of range to a driver of the truck.

14. The container of claim 11 wherein at least one of the condition sensors is a temperature sensor connected to the controller for communicating a signal to the controller representative of the temperature within the container, and wherein the controller is further configured to communicate a temperature signal to a remote system, wherein the remote system is a central computer system which tracks and stores container information for a plurality of containers.

15. The container of claim 1 wherein the electronics module further has a locator unit in communication with the controller for determining the geographic location of the container and for communicating a signal representative of the geographic location to the controller.

16. The container of claim 1 wherein the electronics module further has a timing means for determining when to periodically send data via RF signals to the remote communications device, the data representing a unique identifier of the container and a location of the container.

17. (canceled)

18. (canceled)

19. (canceled)

20. (canceled)

21. (canceled)

22. (canceled)

23. The container of claim 1 wherein the RF reader is configured to read cargo information from an RFID tag associated with each item of cargo as each item of cargo is loaded into the container and removed from the container, and is configured to communicate the cargo information to the controller.

24. The container of claim 23 wherein the controller and RF transceiver are configured to communicate the cargo information, time of loading and time of removal to a central computer system for tracking and storing the cargo information within a cargo inventory database.

25. The container of claim 24 wherein the controller and RF transceiver are configured to communicate the cargo information through a cellular network having a plurality of cell towers.

26. The container of claim 1 wherein the electronics module further has a GPS locator unit in communication with the controller for determining the geographic location of the container, and wherein the controller and the RF transceiver are configured to communicate a signal representative of the geographic location of the container and other the status information about the controller and/or the cargo to a remote central computer system.

27. (canceled)

28. (canceled)

29. (canceled)

30. (canceled)

31. (canceled)

32. (canceled)

33. (canceled)

34. (canceled)

35. (canceled)

36. (canceled)

37. The container of claim 1 further comprising:
an intrusion sensor in communication with the controller for sensing when a person is attempting to penetrate the container.

38. (canceled)

39. (canceled)

40. The container of claim 11 wherein at least one of the condition sensors is a digital camera disposed within the container and in communication with the controller for taking a digital picture each time the lid opens and/or each time a predetermined period of time passes.

41. (canceled)

42. The container of claim 40 wherein the controller and transceiver are configured to communicate the digital picture to a central computer system for tracking and monitoring the container and cargo therein.

43. The container of claim 11 wherein at least one of the condition sensors is a chemical sensor disposed within the container and in communication with the controller for sensing if unwanted chemicals or agents have been introduced into the container.

44. The container of claim 43 wherein the controller and transceiver are configured to communicate chemical information sensed by the chemical sensor to a central computer system for tracking and monitoring the container.

45. The container of claim 1 further comprising:
an audio alarm unit in communication with the controller for generating an audible alarm signal when the controller communicates an alarm signal to the audio alarm unit.

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. A method of shipping cargo in a container capable of shipment within an under-deck locker secured to an under-side of a truck cargo compartment, the locker having a lockable fold-down door for allowing the container to be inserted within and removed from the locker, the container having side and bottom walls forming a unitary container body and an internal space for receiving the cargo; an openable lid hinged to the container body for engaging tops of the side walls; means for locking the lid to the container body for preventing the lid from opening; and, an electronics module disposed within the container, the module having a controller, a battery supply unit connected to and supplying power to the controller, an RF transceiver unit in communication with the controller, and an RFID reader in communication with the controller, the method comprising the steps of:
receiving RFID information from an RFID tag associated with the cargo which has been received within the container; and,
transmitting and receiving communication signals to and from a remote communications device.

60. The method of claim 59 further comprising the steps of:
receiving condition signals at the controller relating to internal conditions of the container from a plurality of condition sensors in communication with the controller and disposed within the container.

61. The method of claim 60 wherein at least one of the condition sensors is a temperature sensor connected to the controller, the method further comprising the steps of:
receiving a signal at the controller representative of the temperature within the container;
determining within an alarm module if the temperature within the container is outside of predetermined thresholds; and,
communicating an alarm signal to a remote receiver, the signal representing that the temperature within the container is out of range to a remote system.

62. The method of claim 60 wherein at least one of the condition sensors is a temperature sensor connected to the controller, the method further comprising the steps of:
receiving a signal at the controller representative of the temperature within the container;
determining within an alarm module if the temperature within the container is outside of predetermined thresholds; and,
communicating an alarm signal to a remote receiver, the signal representing that the temperature within the container is out of range to a central computer system for tracking and storing container information for a plurality of containers.

63. The container of claim 59 further comprising the steps of:
determining the geographic location of the container using a locator unit within the container; and,
receiving a signal representative of the geographic location of the container at the controller.

64. The method of claim 59 further comprising the steps of:
determining when to periodically send data via RF signals to the remote communications device using a timing means within the electronics module, the data representing a unique identifier of the container and a location of the container.

65. The method of claim 59 further comprising the steps of:
reading cargo information from an RFID tag associated with each item of cargo through an RF reader in communication with the controller, as each item of cargo is loaded into the container and removed from the container; and,
receiving the cargo information at the controller.

66. The method of claim 65 further comprising the steps of:
transmitting the cargo information, time of loading and time of removal to a central computer system for tracking and storing the cargo information within a cargo inventory database.

67. The method of claim 59 further comprising the step of:
determining when a person is attempting to penetrate the container using an intrusion sensor.

68. The method of claim 67 further comprising the step of:
issuing an alarm signal to an audible alarm unit.

69. The method of claim 67 further comprising the step of:
transmitting to a central computer system a signal representing that a person is attempting to penetrate the container.

70. The method of claim 59 further comprising the step of:
taking a digital picture each time the lid opens and/or each time a predetermined period of time passes, using a digital camera disposed within the container and in communication with the controller.

71. The method of claim 70 further comprising the step of:
transmitting the digital picture to a central computer system for tracking and monitoring the container and cargo therein.

72. The method of claim 59 further comprising the step of:
sensing if unwanted chemicals or agents have been introduced into the container using a chemical sensor disposed within the container and in communication with the controller.

73. The method of claim 72 further comprising the step of:
transmitting chemical information sensed by the chemical sensor to a central computer system for tracking and monitoring the container.

74. A method of tracking actions associated with a container having side and bottom walls forming a unitary container body and an internal space for receiving the cargo; an openable lid hinged to the container body for engaging tops of the side walls; means for locking the lid to the container body for preventing the lid from opening; and, an electronics module disposed within the container, the module having a controller, a battery supply unit connected to and supplying power to the controller, an RF transceiver unit in communication with the controller, and an RFID reader in communication with the controller, the method comprising the step of:
receiving load/unload cargo information from the controller within the container at a central computer system having a central tracking application for tracking actions associated with the container.

75. The method of claim 74 further comprising the step of:
generating an inventory log of the cargo comprising inventory log information selected from a group consisting of what cargo was loaded or unloaded from the container, the time and date that the loading or unloading occurred, who loaded or unloaded the cargo, and the location of the container when the load or unload occurred.

76. The method of claim 75 further comprising the step of:
transmitting the inventory log to a user selected from a group consisting of a shipper, a customer, an auditor, and a tracking control authority.

77. The method of claim 76 further comprising the step of:
segregating cargo information for a particular user to only include cargo information associated with the particular user in the inventory log before transmitting the inventory log to the user.

78. The method of claim 74 further comprising the steps of:
receiving location information from the controller representing the location of the container at the central computer system; and,
transmitting mapping information to a client computer, using the location information received from the controller.

79. The method of claim 74 further comprising the steps of:
receiving status information representing the status of the container at the central computer system; and,
transmitting the status information to a client computer, using the status information received from the controller.

80. The method of claim 74 further comprising the steps of:
tracking all events for cargo loaded into the container and removed from the container; and,
generating and transmitting to a client computer an audit trail report of all of the tracked events.
